(19) United States
(12) Patent Application Publication
(10) Pub. No.: US 2024/0284282 A1
(43) Pub. Date: Aug. 22, 2024

(54) TECHNIQUES FOR PRECEDENCE BETWEEN LAYER 3 (L3) RECONFIGURATION AND LAYER 1 (L1)/LAYER 2 (L2) TRIGGERED MOBILITY (LTM) EXECUTION

(71) Applicant: QUALCOMM Incorporated, San Diego, CA (US)

(72) Inventors: Naeem AKL, BRIDGEWATER, NJ (US); Ozcan OZTURK, San Diego, CA (US); Jelena DAMNJANOVIC, Del Mar, CA (US)

(21) Appl. No.: 18/438,260

(22) Filed: Feb. 9, 2024

Related U.S. Application Data
(60) Provisional application No. 63/485,491, filed on Feb. 16, 2023.

(51) Int. Cl. H04W 36/08; H04W 36/00; H04W 76/20

(52) U.S. Cl. CPC H04W 36/08; H04W 36/0058; H04W 76/20

(57) ABSTRACT

Methods, systems, and devices for wireless communications are described. In some examples, a first cell of a network entity may receive a first control message indicating a configuration associated with a user equipment (UE). Additionally, the first cell may identify a condition associated with transmitting a second control message indicating for the UE to perform a cell switch procedure. In some examples, the first cell may determine whether to forward the first control message to the UE based on the condition. In some other examples, the first cell may forward the first control message and transmit the second control message within the threshold duration of forwarding the first control message. In such cases, the UE may trigger the cell switch procedure based on receiving the second control message and may determine whether to apply the configuration associated with the first control message.

### CROSS REFERENCE

The present Application for Patent claims the benefit of U.S. Provisional Patent Application No. 63/485,491 by AKL et al., entitled “TECHNIQUES FOR PRECEDENCE BETWEEN LAYER 3 (L3) RECONFIGURATION AND LOCAL TRAFFIC MANAGEMENT (LTM) EXECUTION,” filed Feb. 16, 2023, assigned to the assignee hereof, and expressly incorporated by reference herein.

### FIELD OF TECHNOLOGY

The following relates to wireless communications, including techniques for precedence between layer 3 (L3) reconfiguration and layer 1 (L1)/layer 2 (L2) triggered mobility (LTM) execution.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for precedence between layer 3 (L3) reconfiguration and layer 1 (L1)/layer 2 (L2) triggered mobility (LTM) execution. Generally, the techniques described herein may enable a wireless communications system to avoid or resolve a race condition in which a user equipment (UE) receives a first control message indicating a configuration of the UE within a threshold duration of receiving a second control message indicating for the UE to perform a cell switch procedure. For example, a first cell (e.g., first distributed unit (DU)) of a network entity may receive a first control message (e.g., from a central unit (CU) of the network entity) indicating a configuration associated with the UE. The first cell may identify a condition associated with transmitting a second control message indicating for the UE to perform a cell switch procedure to switch communications with the first cell to a second cell (e.g., second DU) of the network entity. In some examples, the first cell may determine whether to forward the first control message to the UE based on the condition. In some examples, the first cell may forward the first control message and may refrain from transmitting the second control message within a threshold duration of forwarding the first control message. Alternatively, the first cell may transmit the second control message and refrain from forwarding (e.g., discard) the first control message. In such cases, the first cell may transmit an indication that the first cell refrained from forwarding the first control message, transmitted the second control message, or both.

In some other examples, the first cell may forward the first control message and transmit the second control message within the threshold duration of forwarding the first control message, creating a race condition at the UE. In such cases, the UE may trigger the cell switch procedure to switch communications with the first cell to the second cell of the network entity based on receiving the second control message and may determine whether to apply the configuration associated with the first control message. In some examples, the UE may apply the configuration associated with the control message and transmit an indication that the UE applied the configuration. Alternatively, the UE may refrain from applying (e.g., discard) the configuration associated with the control message and may transmit an indication that the UE discarded the first control message.

A method for wireless communications at a first cell of a network entity is described. The method may include receiving a first control message indicating a configuration associated with a UE, identifying a condition associated with transmitting a second control message indicating for the UE to perform a cell switch procedure to switch communications with the first cell to a second cell of the network entity, and determining whether to forward the first control message to the UE based on the condition.

An apparatus for wireless communications at a first cell of a network entity is described. The apparatus may include a processor, memory coupled with the processor, and instructions stored in the memory. The instructions may be executable by the processor to cause the apparatus to receive a first control message indicating a configuration associated with a UE, identify a condition associated with transmitting a second control message indicating for the UE to perform a cell switch procedure to switch communications with the first cell to a second cell of the network entity, and determine whether to forward the first control message to the UE based on the condition.

Another apparatus for wireless communications at a first cell of a network entity is described. The apparatus may include means for receiving a first control message indicating a configuration associated with a UE, means for identifying a condition associated with transmitting a second control message indicating for the UE to perform a cell switch procedure to switch communications with the first cell to a second cell of the network entity, and means for determining whether to forward the first control message to the UE based on the condition.

A non-transitory computer-readable medium storing code for wireless communications at a first cell of a network entity is described. The code may include instructions executable by a processor to receive a first control message indicating a configuration associated with a UE, identify a condition associated with transmitting a second control message indicating for the UE to perform a cell switch procedure to switch communications with the first cell to a second cell of the network entity, and determine whether to forward the first control message to the UE based on the condition.

In some examples of the method, apparatuses, and non-transitory computer-readable medium described herein, the first cell may be associated with a first distributed unit (DU) of the network entity and the second cell may be associated with a second DU of the network entity.

Some examples of the method, apparatuses, and non-transitory computer-readable medium described herein may further include operations, features, means, or instructions for receiving assistance information associated with the first control message, where determining whether to forward the first control message may be based on the assistance information.

In some examples of the method, apparatuses, and non-transitory computer-readable medium described herein, the first control message or a third control message include the assistance information.

In some examples of the method, apparatuses, and non-transitory computer-readable medium described herein, the assistance information includes a duration associated with applying the first control message, a condition associated with forwarding the first control message, a precedence associated with forwarding the first control message, or any combination thereof.

In some examples of the method, apparatuses, and non-transitory computer-readable medium described herein, the assistance information may be associated with the first control message, a first type of control message associated with the first control message, a signaling radio bearer (SRB) associated with the first control message, or any combination thereof.

Some examples of the method, apparatuses, and non-transitory computer-readable medium described herein may further include operations, features, means, or instructions for transmitting the first control message based on one or more measurements associated with a communication link with the first cell exceeding a threshold, where the condition may be associated with the one or more measurements.

Some examples of the method, apparatuses, and non-transitory computer-readable medium described herein may further include operations, features, means, or instructions for refraining from transmitting the second control message based on transmitting the first control message.

Some examples of the method, apparatuses, and non-transitory computer-readable medium described herein may further include operations, features, means, or instructions for transmitting the second control message a threshold duration after transmitting the first control message, where the threshold duration may be based on an application time of the first control message.

Some examples of the method, apparatuses, and non-transitory computer-readable medium described herein may further include operations, features, means, or instructions for transmitting the second control message based on one or more measurements associated with a communication link with the first cell failing to exceed a threshold, where the condition may be associated with the one or more measurements.

Some examples of the method, apparatuses, and non-transitory computer-readable medium described herein may further include operations, features, means, or instructions for refraining from forwarding the first control message based on transmitting the second control message.

Some examples of the method, apparatuses, and non-transitory computer-readable medium described herein may further include operations, features, means, or instructions for transmitting an indication that the first cell refrained from forwarding the first control message, transmitted the second control message, or both.

Some examples of the method, apparatuses, and non-transitory computer-readable medium described herein may further include operations, features, means, or instructions for transmitting the first control message and transmitting the second control message within a threshold duration of transmitting the first control message, where the threshold duration may be based on an application time of the first control message.

In some examples of the method, apparatuses, and non-transitory computer-readable medium described herein, the first control message and the second control message may be associated with a same transport block (TB).

A method for wireless communications at a UE is described. The method may include receiving, from a first cell of a network entity, a first control message indicating a configuration associated with the UE, receiving, from the first cell, a second control message indicating for the UE to perform a cell switch procedure, where the second control message is received within a threshold duration of receipt of the first control message, triggering the cell switch procedure to switch communications with the first cell to a second cell of the network entity based on receiving the second control message, and transmitting an indication of whether the UE applied the configuration associated with the first control message.

An apparatus for wireless communications at a UE is described. The apparatus may include a processor, memory coupled with the processor, and instructions stored in the memory. The instructions may be executable by the processor to cause the apparatus to receive, from a first cell of a network entity, a first control message indicating a configuration associated with the UE, receive, from the first cell, a second control message indicating for the UE to perform a cell switch procedure, where the second control message is received within a threshold duration of receipt of the first control message, trigger the cell switch procedure to switch communications with the first cell to a second cell of the network entity based on receiving the second control message, and transmit an indication of whether the UE applied the configuration associated with the first control message.

Another apparatus for wireless communications at a UE is described. The apparatus may include means for receiving, from a first cell of a network entity, a first control message indicating a configuration associated with the UE, means for receiving, from the first cell, a second control message indicating for the UE to perform a cell switch procedure, where the second control message is received within a threshold duration of receipt of the first control message, means for triggering the cell switch procedure to switch communications with the first cell to a second cell of the network entity based on receiving the second control message, and means for transmitting an indication of whether the UE applied the configuration associated with the first control message.

A non-transitory computer-readable medium storing code for wireless communications at a UE is described. The code may include instructions executable by a processor to receive, from a first cell of a network entity, a first control message indicating a configuration associated with the UE, receive, from the first cell, a second control message indicating for the UE to perform a cell switch procedure, where the second control message is received within a threshold duration of receipt of the first control message, trigger the cell switch procedure to switch communications with the first cell to a second cell of the network entity based on receiving the second control message, and transmit an indication of whether the UE applied the configuration associated with the first control message.

In some examples of the method, apparatuses, and non-transitory computer-readable medium described herein, the UE transmits the indication that the UE applied the configuration associated with the first control message.

Some examples of the method, apparatuses, and non-transitory computer-readable medium described herein may further include operations, features, means, or instructions for applying the configuration associated with the first control message based on the first control message being associated with a first type of control message.

In some examples of the method, apparatuses, and non-transitory computer-readable medium described herein, the first type of control message may be a RRC message.

Some examples of the method, apparatuses, and non-transitory computer-readable medium described herein may further include operations, features, means, or instructions for applying the configuration associated with the first control message based at least in part a second configuration associated with the UE.

In some examples of the method, apparatuses, and non-transitory computer-readable medium described herein, the second configuration indicates for the UE to apply control messages associated with a first type of control message, and the first control message may be associated with the first type of control message.

In some examples of the method, apparatuses, and non-transitory computer-readable medium described herein, the second configuration indicates for the UE to apply the first control message.

In some examples of the method, apparatuses, and non-transitory computer-readable medium described herein, the second configuration indicates for the UE to apply control messages associated with a first SRB and the first control message may be associated with the first SRB.

In some examples of the method, apparatuses, and non-transitory computer-readable medium described herein, the second configuration indicates a threshold duration and a duration between applying the first control message and triggering the cell switch procedure satisfies the threshold duration.

Some examples of the method, apparatuses, and non-transitory computer-readable medium described herein may further include operations, features, means, or instructions for applying the configuration associated with the UE based on the configuration indicated via the first control message.

In some examples of the method, apparatuses, and non-transitory computer-readable medium described herein, the configuration may be associated with a set of multiple cells of the network entity, the set of multiple cells including at least the first cell and the second cell.

In some examples of the method, apparatuses, and non-transitory computer-readable medium described herein, the first control message includes an indication of the association between the configuration and the set of multiple cells.

In some examples of the method, apparatuses, and non-transitory computer-readable medium described herein, the UE transmits the indication that the UE discarded the configuration associated with the first control message.

Some examples of the method, apparatuses, and non-transitory computer-readable medium described herein may further include operations, features, means, or instructions for discarding the configuration associated with the UE based on the configuration indicated via the first control message.

In some examples of the method, apparatuses, and non-transitory computer-readable medium described herein, the configuration may be associated with the first cell of the network entity.

In some examples of the method, apparatuses, and non-transitory computer-readable medium described herein, the first control message includes an indication of the association between the configuration and the first cell.

Some examples of the method, apparatuses, and non-transitory computer-readable medium described herein may further include operations, features, means, or instructions for discarding the configuration associated with the first control message based on the first control message being received within the threshold duration of receipt of the second control message.

A method for wireless communications at a first cell of a network entity is described. The method may include transmitting a first control message indicating assistance information associated with a second control message, where the second control message indicates a configuration associated with a UE, and where the assistance information is associated with a second cell of the network entity determining whether to forward the first control message and transmitting the second control message indicating the configuration associated with the UE based on transmitting the assistance information.

An apparatus for wireless communications at a first cell of a network entity is described. The apparatus may include a processor, memory coupled with the processor, and instructions stored in the memory. The instructions may be executable by the processor to cause the apparatus to transmit a first control message indicating assistance information associated with a second control message, where the second control message indicates a configuration associated with a UE, and where the assistance information is associated with a second cell of the network entity determining whether to forward the first control message and transmit the second control message indicating the configuration associated with the UE based on transmitting the assistance information.

Another apparatus for wireless communications at a first cell of a network entity is described. The apparatus may include means for transmitting a first control message indicating assistance information associated with a second control message, where the second control message indicates a configuration associated with a UE, and where the assistance information is associated with a second cell of the network entity determining whether to forward the first control message and means for transmitting the second control message indicating the configuration associated with the UE based on transmitting the assistance information.

A non-transitory computer-readable medium storing code for wireless communications at a first cell of a network entity is described. The code may include instructions executable by a processor to transmit a first control message indicating assistance information associated with a second control message, where the second control message indicates a configuration associated with a UE, and where the assistance information is associated with a second cell of the network entity determining whether to forward the first control message and transmit the second control message indicating the configuration associated with the UE based on transmitting the assistance information.

In some examples of the method, apparatuses, and non-transitory computer-readable medium described herein, the assistance information includes a duration associated with applying the second control message, a condition associated with forwarding the second control message, a precedence associated with forwarding the second control message, or any combination thereof.

In some examples of the method, apparatuses, and non-transitory computer-readable medium described herein, the assistance information may be associated with the second control message, a first type of control message associated with the second control message, an SRB associated with the second control message, or any combination thereof.

In some examples of the method, apparatuses, and non-transitory computer-readable medium described herein, the first control message and the second control message may be a same control message.

Some examples of the method, apparatuses, and non-transitory computer-readable medium described herein may further include operations, features, means, or instructions for receiving an indication that the second cell refrained from forwarding the second control message, transmitted a third control message indicating for the UE to perform a cell switch procedure, or both.

Some examples of the method, apparatuses, and non-transitory computer-readable medium described herein may further include operations, features, means, or instructions for receiving an indication that the UE applied the second control message or discarded the second control message.

In some examples of the method, apparatuses, and non-transitory computer-readable medium described herein, the first cell may be a central unit (CU) of the network entity and the second cell may be a DU of the network entity.

### BRIEF DESCRIPTION OF THE DRAWINGS

FIG. 1 illustrates an example of a wireless communications system that supports techniques for precedence between layer 3 (L3) reconfiguration and layer 1 (L1)/layer 2 (L2) triggered mobility (LTM) execution in accordance with one or more aspects of the present disclosure.

FIG. 2 illustrates an example of a network architecture that supports techniques for precedence between L3 reconfiguration and LTM execution in accordance with one or more aspects of the present disclosure.

FIG. 3 illustrates an example of a wireless communications system that supports techniques for precedence between L3 reconfiguration and LTM execution in accordance with one or more aspects of the present disclosure.

FIG. 4 illustrates an example of a wireless communications system that supports techniques for precedence between L3 reconfiguration and LTM execution in accordance with one or more aspects of the present disclosure.

FIG. 5 illustrates an example of a process flow that supports techniques for precedence between L3 reconfiguration and LTM execution in accordance with one or more aspects of the present disclosure.

FIG. 6 illustrates an example of a process flow that supports techniques for precedence between L3 reconfiguration and LTM execution in accordance with one or more aspects of the present disclosure.

FIGS. 7 and 8 illustrate block diagrams of devices that support techniques for precedence between L3 reconfiguration and LTM execution in accordance with one or more aspects of the present disclosure.

FIG. 9 illustrates a block diagram of a communications manager that supports techniques for precedence between L3 reconfiguration and LTM execution in accordance with one or more aspects of the present disclosure.

FIG. 10 illustrates a diagram of a system including a device that supports techniques for precedence between L3 reconfiguration and LTM execution in accordance with one or more aspects of the present disclosure.

FIGS. 11 and 12 illustrate block diagrams of devices that support techniques for precedence between L3 reconfiguration and LTM execution in accordance with one or more aspects of the present disclosure.

FIG. 13 illustrates a block diagram of a communications manager that supports techniques for precedence between L3 reconfiguration and LTM execution in accordance with one or more aspects of the present disclosure.

FIG. 14 illustrates a diagram of a system including a device that supports techniques for precedence between L3 reconfiguration and LTM execution in accordance with one or more aspects of the present disclosure.

FIGS. 15 through 17 illustrate flowcharts showing methods that support techniques for precedence between L3 reconfiguration and LTM execution in accordance with one or more aspects of the present disclosure.

### DETAILED DESCRIPTION

Some wireless communications systems may support communications between a user equipment (UE) and a network entity, where the network entity is implemented in a disaggregated architecture. For example, the network entity may be associated with a central unit (CU) and one or more distributed units (DUs), including at least a first DU and a second DU, such that the CU may communicate with the UE via the first DU, the second DU, or both, and each DU may communicate with the UE directly. In some examples, the CU may transmit a first control message, such as a radio resource control (RRC) message, to the UE via the first DU. Additionally, the first DU may transmit a second control message to the UE, indicating for the UE to switch communications with the first DU to the second DU. In other words, the first DU may transmit the second control message, which may be referred to as a layer 1 (L1)/layer 2 (L2) triggered mobility (LTM) message, triggering an LTM cell switch in which the UE switches communications with the first DU to the second DU. However, in some examples, the CU may transmit the first control message via the first DU within a threshold duration of the first DU transmitting the second control message, which may result in a race condition. In other words, the UE may initiate the LTM cell switch while the UE is receiving the RRC message, processing the RRC message, or both. In such cases, the UE may be unable to determine whether to apply the first control message and the network entity may be unable to determine whether the UE applied the first control message.

Accordingly, techniques described herein may support avoidance or resolution of race conditions. In some examples, a wireless communications system described herein may support avoidance of race conditions. In such cases, the CU may transmit an RRC message to the first DU and the first DU may determine whether to forward the RRC message to the UE. For example, the first DU may determine to trigger an LTM cell switch, such that the first DU transmits an LTM message to the UE and refrains from forwarding the RRC message. In such cases, the first DU may transmit a feedback message to the CU indicating that the first DU refrained from forwarding the RRC message. Alternatively, the first DU may determine to forward the RRC message and may refrain from triggering the LTM cell switch within a duration associated with processing the RRC message.

Alternatively, the wireless communications systems described herein may support resolution of the race condition. For example, the UE may receive both the RRC message and the LTM message and may determine whether to apply the RRC message. In some examples, the UE may determine to always apply RRC messages in a race condition. In some other examples, the UE may determine to apply the RRC message based on a configuration of the UE, based on the contents of the RRC message, or both. Alternatively, the UE may determine to never apply RRC messages in a race condition. Additionally, the UE may transmit a feedback message indicating whether the UE applied the RRC message.

Aspects of the disclosure are initially described in the context of wireless communications systems. Aspects of the disclosure may then be described in the context of a process flow. Aspects of the disclosure are further illustrated by and described with reference to apparatus diagrams, system diagrams, and flowcharts that relate to precedence between layer 3 (L3) reconfiguration and LTM execution.

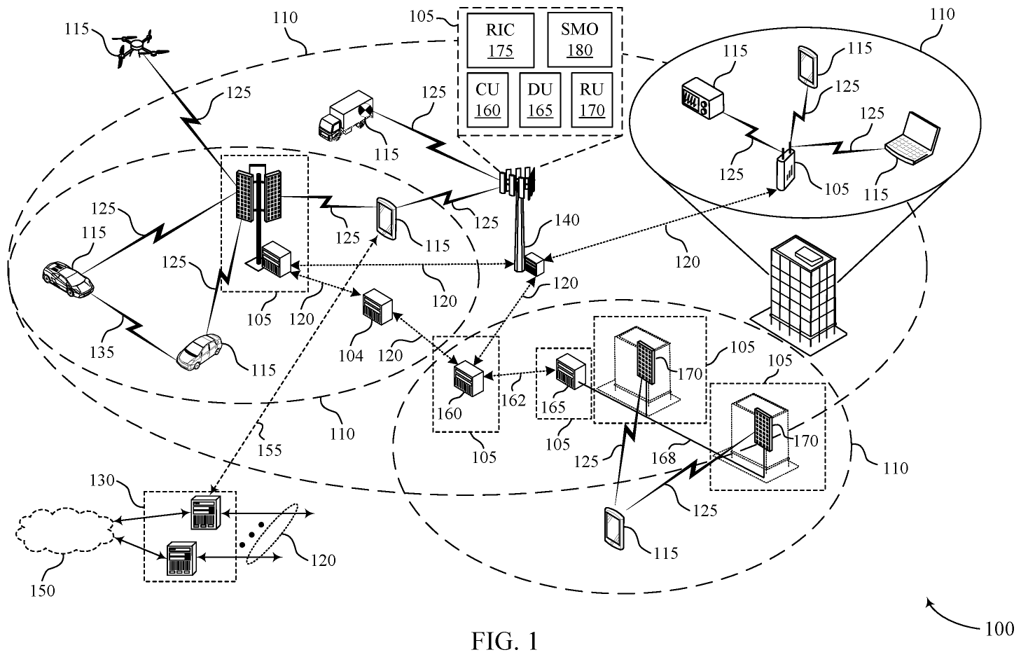

FIG. 1 illustrates an example of a wireless communications system 100 that supports techniques for precedence between L3 reconfiguration and LTM execution in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a

disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., L3, L2) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as L1 (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for precedence between L3 reconfiguration and LTM execution as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize licensed RF spectrum bands, unlicensed RF spectrum bands, or both. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described previously, the wireless communications systems 100 may support communications between a UE 115 and a network entity 105, where the network entity 105 is implemented in a disaggregated architecture. For example, the network entity 105 may be associated with a CU 160 and one or more DUs 165, including at least a first DU 165 and a second DU 165, such that the CU 160 may communicate with the UE 115 via the first DU 165, the second DU 165, or both, and each DU 165 may communicate with the UE 115 directly.

In some examples, the wireless communications system 100 may support avoidance of a race condition, in the CU 160 transmits a first control message, such as a RRC message, to the UE 115 via the first DU 165 within a time threshold that the first DU 165 transmits a second control message, which may be referred to as an LTM message, to the UE 115 indicating for the UE 115 to switch communications with the first DU 165 to the second DU 165. That is, the CU 160 may transmit an RRC message to the first DU 165 and the first DU 165 may determine whether to forward the RRC message to the UE 115. For example, the first DU 165 may determine to trigger an LTM cell switch, such that the first DU 165 transmits an LTM message to the UE 115 and refrains from forwarding the RRC message. In such cases, the first DU 165 may transmit a response message to the CU 160 indicating that the first DU 165 refrained from forwarding the RRC message. Alternatively, the first DU 165 may determine to forward the RRC message and refrain from triggering the LTM cell switch within a duration associated with processing the RRC message.

Alternatively, the wireless communications systems described herein may support resolution of the race condition. For example, the UE 115 may receive both the RRC message and the LTM message and may determine whether to apply the RRC message. In some examples, the UE 115 may determine to always apply RRC messages in a race condition. In some other examples, the UE 115 may determine to apply the RRC message based on a configuration of the UE 115, based on the contents of the RRC message, or both. Alternatively, the UE 115 may determine to never apply RRC messages in a race condition. Additionally, the UE 115 may transmit a feedback message indicating whether the UE 115 applied the RRC message.

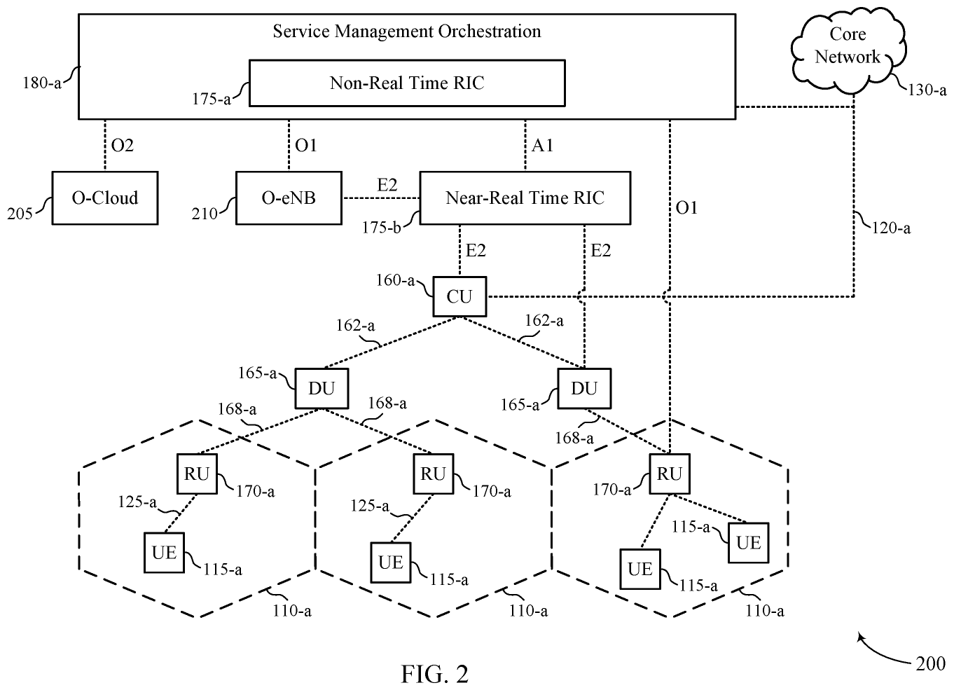

FIG. 2 illustrates an example of a network architecture 200 (e.g., a disaggregated base station architecture, a disaggregated RAN architecture) that supports techniques for precedence between L3 reconfiguration and LTM execution in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

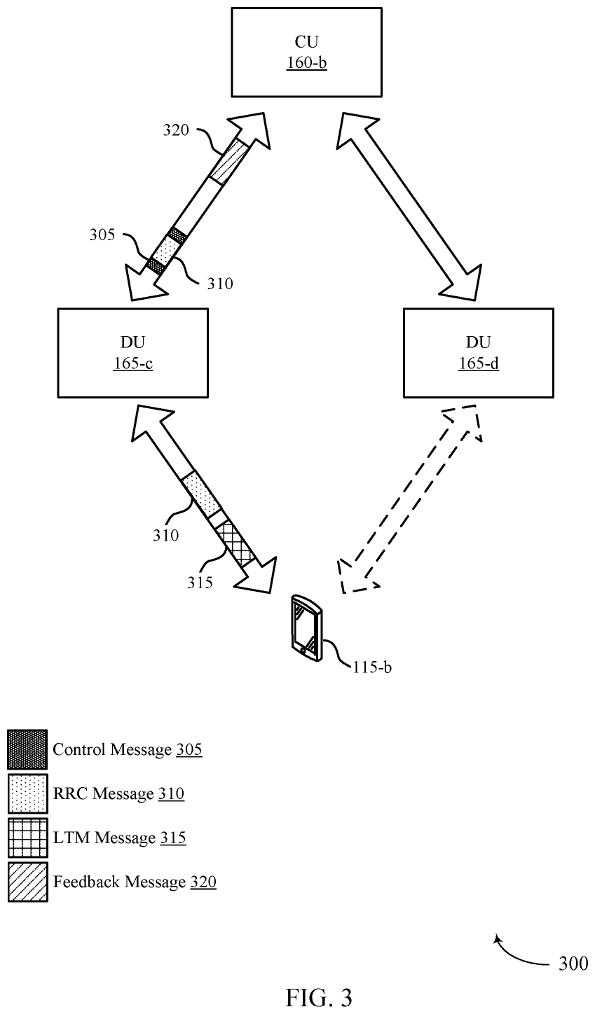

FIG. 3 illustrates an example of a wireless communications system 300 that supports techniques for precedence between L3 reconfiguration and LTM execution in accordance with one or more aspects of the present disclosure. The wireless communications system 300 may implement or be implemented by aspects of the wireless communications system 100 and the network architecture 200. For example, the wireless communications system 300 may include one or more network entities 105 (e.g., a network entity 105 associated with a CU 160-b, a DU 165-, and a DU 165-d) and one or more UEs 115 (e.g., a UE 115-b), which may represent examples of corresponding devices as described with reference to FIG. 1. In some examples, the DU 165-b may support avoidance of a race condition based on determining whether to forward an RRC message 310.

The wireless communications system 300 may support communications between a UE 115-b and a network entity 105, where the network entity 105 is implemented in a disaggregated architecture. For example, the network entity 105 may be associated with (e.g., include) a CU 160-b (e.g., serving CU 160-b) and one or more DUs 165, including at least a DU 165-c and a DU 165-d, such that the CU 160-b may communicate with the UE 115-b via the DU 165-c, the DU 165-d, or both, and each DU 165 may communicate with the UE 115-b directly. In some examples, the DU 165-c may be a serving DU 165, such that the CU 160-b communicates with the UE 115-b via the DU 165-c, as illustrated in FIG. 3.

In some cases, the CU 160-b may transmit a control message 305 (e.g., FIAP message) to the DU 165-c including (e.g., indicating) an RRC message 310 (e.g., RRC container) to be forward to the UE 115-b, such that the DU 165-c may forward the RRC message 310 to the UE 115-b. In some examples, the RRC message 310 may be an RRC reconfiguration message (e.g., L3 RRC reconfiguration message). That is, the RRC message 310 may indicate a configuration associated with the UE 115-b.

In some examples, a delay, which may be referred to as an RRC procedure delay or an RRC application delay, may exist between reception of the RRC message 310 by the UE 115-b (e.g., receipt of the RRC message 310 on a physical layer of the UE 115-b) and application of the RRC message 310 (e.g., the UE 115-b being ready for reception of an uplink grant for the UE 115-b). In other words, the RRC procedure delay may be a duration between reception of the RRC message 310 by the UE 115-b and reception of a response message (e.g., an RRC response transmitted by the UE 115-b) by the CU 160-b (e.g., with no access delay other than TTI alignment). The RRC procedure delay may exclude delays as a result of (e.g., caused by) scheduling, random access procedures, or physical layer synchronization.

Additionally, or alternatively, the RRC message 310 may trigger bandwidth part (BWP) switching. In such cases, the RRC procedure delay may be based on a table (e.g., a table of values). For example, the RRC message 310 (e.g., RRC reconfiguration message) may indicate a configuration associated with the UE 115-b (e.g., and may not add or release cells), such that the UE 115-b may transmit a response message indicating successful application of the RRC message 310 (e.g., RRC reconfiguration is complete). In such cases, the RRC procedure delay between the RRC message 310 and the response message may be 10 ms. In another example, the RRC message 310 may indicate a configuration associated with the UE 115-a, where the configuration is associated with adding or releasing a DU 165 (e.g., cell) associated with the network entity 105. In such cases, the RRC procedure delay between the RRC message 310 and the response message may be 16 ms.

Additionally, or alternatively, the DU 165-c may transmit an LTM message 315 (e.g., LTM MAC-control element (CE) message) to the UE 115-b to trigger the UE 115-b to perform LTM cell switching (e.g., perform an LTM cell switch procedure). In other words, the LTM message 315 may trigger the UE 115-b to switch communications with the DU 165-c to another DU 165 of the network entity 105, such as the DU 165-d. For example, the UE 115-b may transmit a first measurement report (e.g., MeasurementReport) message to the CU 160-b (e.g., via the DU 165-c) and the CU 160-b may determine to use LTM and initiate LTM candidate preparation. In such cases, an LTM candidate (e.g., LTM candidate target cell) may be an additional DU 165 associated with the network entity 105, including at least the DU 165-d. That is, the CU 160-b may transmit a first control message 305 (e.g., RRCReconfiguration message) to the UE 115-b indicating a configuration associated with each candidate DU 165 of a set of candidate DUs 165 (e.g., DUs 165 associated with the network entity 105). The UE 115-b may store the configurations associated with the set of candidate DUs 165 and transmit a response message (e.g., RRCReconfigurationComplete message) to the CU 160-b indicating that the UE 115-b stored the configurations. Additionally, the UE 115-b may perform a downlink synchronization procedure and a timing advance (TA) acquisition procedure associated with the set of candidate DUs 165. Additionally, the UE 115-b may perform measurements (e.g., L1 measurements) associated with the set of candidate DUs 165 and may report (e.g., via a second measurement report) one or more of the measurements (e.g., lower-layer measurements as compared to those transmitted via the first measurement report) to the DU 165-c. As such, the DU 165-c may transmit, to the UE 115-b, an LTM message 315 (e.g., LTM cell switch command) indicating for the UE 115-b to switch communications with the DU 165-c to a candidate DU 165 from the set of candidate DUs 165, such as the DU 165-d, (e.g., perform the LTM cell switch procedure). The LTM message 315 may indicate an index (e.g., candidate configuration index) associated with the DU 165-d (e.g., LTM candidate target cell). As such, the UE 115-b may switch communications with the DU 165-c to the DU 165-d (e.g., switch to a configuration of the LTM candidate target cell) and may perform a random access procedure associated with the DU 165-d (e.g., if TA is not available). In other words, the UE 115-b may detach from the DU 165-c (e.g., source DU 165) and apply a configuration associated with the DU 165-d (e.g., from the stored configurations). The UE 115-b may indicate, to the DU 165-d, successful application of the LTM message 315 (e.g., successful completion of the LTM cell switch towards the DU 165-d).

However, in some examples, the CU 160-b may transmit an RRC message 310 (e.g., a L3 RRC reconfiguration message) within a threshold duration (e.g., based on an RRC procedure delay) of the DU 165-c transmitting an LTM message 315, which may result in a race condition. In other words, the UE 115-b may receive the LTM message 315 within an RRC procedure delay associated with the RRC message 310, such that the network entity 105 may not be aware of whether the RRC message 310 or the LTM message 315 was received by the UE 115-b first, and the UE 115-a may be unable to determine whether to apply the RRC message 310. For example, (e.g., in a first race condition), the CU 160-b may transmit the RRC message 310 to the UE 115-b via the DU 165-c, however, prior to reception of the RRC message 310 by the UE 115-b, the UE 115-b may execute the LTM cell switch (e.g., LTM cell switch procedure) towards the DU 165-c based on receiving the LTM message 315 from the DU 165-c. In such cases, the UE 115-b may miss reception of (e.g., may not receive) the RRC message 310 and may not be aware of the missed RRC message 310 (e.g., may not be aware that the RRC message 310 was missed). In other words, the UE 115-b may receive and process the LTM message 315 (e.g., perform the LTM cell switch procedure) prior to reception (e.g., full reception) of the RRC message 310, such that the UE 115-b does not receive the RRC message 310, which may result in security issues (e.g., security issues related to packet data convergence (PDCP) sequence number (SN)).

In another example (e.g., a second race condition), the UE 115-b may receive (e.g., fully receive) and process the RRC message 310 prior to receipt, processing, or both, of the LTM message 315. Additionally, or alternatively (e.g., in a third race condition), the UE 115-b may receive the RRC message 310 (e.g., first), however, the UE 115-b may receive the LTM message 315 prior to processing (e.g., and applying) the RRC message 310. Additionally, or alternatively (e.g., in a fourth race condition), the UE 115-b may receive the RRC message 310 and the LTM message 315 simultaneously (e.g., together). In the prior examples (e.g., the first race condition, the second race condition, and the third race condition), the CU 160-b may determine (e.g., be aware of) whether the RRC message 310 was transmitted to the UE 115-b via the DU 165-c based on one or more reports transmitted from the DU 165-c to the CU 160-b (e.g., RLC status reports, RRC delivery reports in F1AP in response to an RRC delivery status request, or both). However (e.g., depending on a time of reception of the RRC message 310, processing capabilities of the UE 115-b, or both), the UE 115-b may be unable to determine whether to apply the RRC message 310 (e.g., and leave the DU 165-c as the serving DU 165) or discard the RRC message 310 and apply the LTM message 315 (e.g., execute the LTM cell switch command). Additionally, or alternatively, the CU 160-b may be unable to determine whether the UE 115-b applied (e.g., in part of full) or will apply the RRC message 310 (e.g., the CU 160-b and the UE 115-b may not be in sync on what RRC configuration has been applied or should be applied).

Accordingly, techniques described herein may support avoiding or resolving race conditions in the wireless communications system 300. For example, as described previously, the CU 160-b may communicate with the UE 115-b via the DU 165-c (e.g., the DU 165-c may be a serving DU 165). The CU 160-b may transmit, to the DU 165-c, a control message 305 (e.g., F1AP message) including an RRC message 310 (e.g., RRC container) to be forwarded to the UE 115-b. Additionally, the DU 165-c may receive, from the UE 115-b (e.g., prior to the control message 305), one or more measurement reports associated with one or more candidate DUs 165 (e.g., LTM candidate target cells), including at least the DU 165-d. As such, the DU 165-c may determine whether to forward (e.g., transmit) the RRC message 310 to the UE 115-b or to trigger the UE 115-b to perform an LTM cell switch procedure via transmission of an LTM message 315.

In some examples, the CU 160-b may indicate (e.g., to the DU 165-c) whether the RRC message 310 should be forwarded to the UE 115-b (e.g., close to transmission of the LTM message 315). For example, the control message 305 (e.g., or an additional control message 305) may include an indication of a precedence between the LTM message 315 and the RRC message 310. That is, the control message 305 (e.g., F1AP message) may indicate whether the RRC message 310 has a higher priority that the LTM message 315 (e.g., whether the RRC message 310 should be forwarded). In some examples, the control message 305 (e.g., or the additional control message 305) may indicate a threshold duration associated with transmitting the LTM message 315. That is, the threshold duration may indicate a duration (e.g., minimum time duration) between forwarding of the RRC message 310 (e.g., if the RRC message should be forwarded as permitted by link conditions) and transmission of the LTM message 315.

In some examples, the indication of the precedence, the threshold duration, or both, which may be referred to as a forwarding configuration, may be associated with a type of control message 305 (e.g., RRC). For example, the type of control message 305 may be RRC messages 310, such that the DU 165-c applies the forwarding configuration for control messages 305 that are RRC messages 310. Additionally, or alternatively, the forwarding configuration may be based on a signaling radio bearer (SRB). For example, the forwarding configuration may be associated with a first SRB, such that the DU 165-c applies the forwarding configuration for control messages 305 associated with the first SRB. Additionally, or alternatively, the forwarding configuration may be control message 305 specific. For example, the forwarding configuration may be associated with the received RRC message 310. In such cases, the control message 305 (e.g., F1AP message) may include an indication (e.g., flag) that the forwarding configuration is associated with the received RRC message 310.

Additionally, or alternatively, the DU 165-c may determine whether to forward the RRC message 310 based on a condition associated with the one or more measurement reports (e.g., one or more measurement reports associated with the candidate DUs 165). For example, the DU 165-c may determine to transmit the LTM message 315 based on one or more measurements associated with the DU 165-d exceeding a threshold (e.g., or one or more measurement associated with the DU 165-c failing to exceed a threshold). Conversely, the DU 165-c may determine to forward the RRC message 310 based on one or more measurements associated with the DU 165-d failing to exceed the threshold (e.g., or one or more measurement associated with the DU 165-c exceeding a threshold). In other words, the DU 165-c may determine to transmit the LTM message 315 based on one or more measurements associated with a communication link between the DU 165-c and the UE 115-b failing to exceed a first threshold (e.g., the communication link between the DU 165-c and the UE 115-b is degraded), based on one or more measurements associated with a communication link between the DU 165-d and the UE 115-b exceeding a second threshold (e.g., the communication link between the DU 165-d and the UE 115-b is associated with a higher link quality than the communication link between the DU 165-c and the UE 115-b), or both.

In some examples, the DU 165-c may determine to trigger the UE 115-b to perform the LTM cell switch procedure (e.g., rather than forward the RRC message 310) and may transmit the LTM message 315 to the UE 115-b. In some examples, the DU 165-c may determine to transmit the LTM message 315 based on the one or more measurement reports. For example, one or more measurements associated with the DU 165-d may exceed a threshold, such that the DU 165-c may determine to transmit the LTM message 315 indicating the DU 165-d. In such cases, the DU 165-c may transmit a feedback message 320 to the CU 160-b indicating that the DU 165-c refrained from forwarding (e.g., discarded) the RRC message 310. Additionally, or alternatively, the feedback message 320 may indicate that the DU 165-c transmitted the LTM message 315 (e.g., the LTM cell switch procedure was triggered for the UE 115-b).

Alternatively, the DU 165-c may determine to forward the RRC message 310. In such cases, the DU 165-c may refrain from transmitting the LTM message 315. For example, the DU 165-c may refrain from transmitting the LTM message 315 within a threshold duration (e.g., as indicated via the RRC message 310 from the CU 160-b) of forwarding the RRC message 310. The threshold duration may be based on a duration associated with the UE 115-b processing and applying the RRC message 310 (e.g., an RRC procedure delay associated with the RRC message 310).

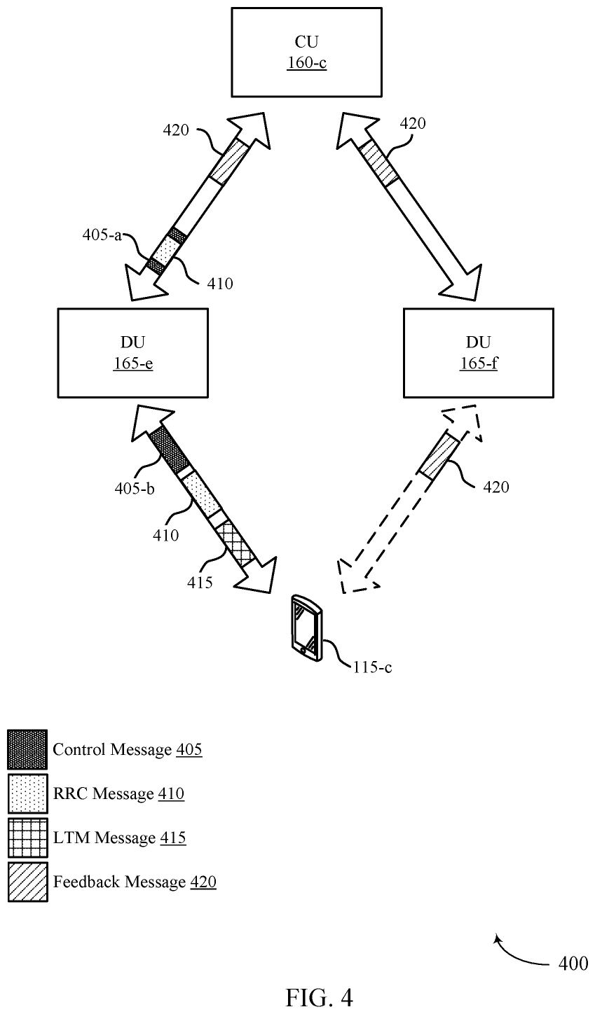

In some other examples, the UE 115-b may determine whether to apply the RRC message 310 in a race condition, as described with reference to FIG. 4

Though described in the context of an RRC message 310, this is not to be regarded as a limitation of the present disclosure. In this regard, any control message, such as a handover command, may be considered with regards to the techniques described herein

FIG. 4 illustrates an example of a wireless communications system 400 that supports techniques for precedence between L3 reconfiguration and LTM execution in accordance with one or more aspects of the present disclosure. The wireless communications system 400 may implement or be implemented by aspects of the wireless communications system 100, the network architecture 200, or the wireless communications system 300. For example, the wireless communications system 400 may include one or more network entities 105 (e.g., a network entity 105 associated with a CU 160-c, a DU 165-e, and a DU 165-f) and one or more UEs 115 (e.g., a UE 115-c), which may represent examples of corresponding devices as described with reference to FIG. 1. In some examples, the DU 165-b may support avoidance of a race condition based on determining whether to forward an RRC message 310.

In some examples, a CU 160-c may communicate with a UE 115-c via a DU 165-e (e.g., the DU 165-e may be a serving DU 165). The CU 160-c may transmit, to the DU 165-e, a control message 405-a (e.g., F1AP message) including an RRC message 410 (e.g., RRC container) to be forwarded to the UE 115-c. Additionally, the DU 165-e may receive, from the UE 115-c (e.g., prior to the control message 405-a), one or more measurement reports associated with one or more candidate DUs 165 (e.g., LTM candidate target cells), including at least the DU 165-f. As such, the DU 165-e may forward, to the UE 115-c, the RRC message 410 (e.g., according to normal scheduling associated with the RRC message 410), and may transmit, to the UE 115-c, an LTM message 415 (e.g., LTM MAC-CE) indicating for the UE 115-c to perform an LTM cell switch procedure to switch communications with the DU 165-e to the DU 165-f. In some examples, the DU 165-e may transmit the RRC message 410 and the LTM message 415 in a same transport block (TB) (e.g., transmit the RRC message 410 and the LTM message 415 together). In some other examples, the DU 165-e may transmit the LTM message 415 to the UE 115-c after forwarding the RRC message 410. As such, a race condition may exist at the UE 115-c. That is, the UE 115-c may receive the LTM message 415 within a threshold duration of reception of the RRC message 410, where the threshold duration is based on a processing duration associated with the RRC message 410. As such, the UE 115-c may determine whether to apply the RRC message 410 (e.g., apply a configuration indicated via the RRC message 410).

In some examples, the UE 115-c may always apply received RRC messages 410 (e.g., in a race condition). For example, the configuration indicated via the RRC message 410 may be associated with multiple DUs 165 further associated with the network entity 105, including at least the DU 165-e and the DU 165-f (e.g., the configuration may be generic). In such cases, the UE 115-c may apply the indicated configuration. In some other examples, the configuration indicated via the RRC message 410 may be associated with the DU 165-e. In such cases, the UE 115-c may process the RRC message 410 and may store the configuration, such that the UE 115-c may apply the configuration based on communicating with the DU 165-e. In other words, the UE 115-c may apply the configuration (e.g., associated with the DU 165-e) indicated via the RRC message 410 based on switching communications back to the DU 165-e (e.g., the UE 115-c may process current and past cell group (CG) configurations).

Additionally, or alternatively, the UE 115-c may determine whether to apply a received RRC message 410 (e.g., in a race condition) based on a configuration of the UE 115-c. In other words, the DU 165-e may transmit (e.g., the CU 160-c may transmit via the DU 165-e) a control message 405-b indicating a configuration (e.g., to be applied by the UE 115-c) associated with forwarding RRC message 410. For example, the control message 405-b may indicate a threshold duration associated with processing RRC messages 410. In some examples, the threshold duration may be based on a capability of the UE 115-c. That is, the UE 115-c may transmit (e.g., to the CU 160-c via the DU 165-e) an indication of a capability of the UE 115-c to process, respond, or both, to an RRC message 410 following application of an LTM message 415 (e.g., a minimum duration or time separation for receiving an RRC message 410 prior to execution of a cell switch procedure triggered via an LTM message 415). As such, the UE 115-c may process RRC message 410 received at reception times prior to the threshold duration from reception of the LTM message 415 (e.g., RRC messages 410 received before the threshold duration from reception of the LTM message 415). In some examples, the UE 115-c may transmit a feedback message 420 indicating radio link failure (RLF) based on the UE 115-c failing to apply the indicated configuration (e.g., failing to apply the RRC message 410).

Additionally, or alternatively, the UE 115-c may determine whether to apply an RRC messages 410 (e.g., in a race condition) based on the RRC message 410. That is, the UE 115-c may determine whether to apply the RRC messages 410 based on an RRC message 410 type associated with the RRC message 410, contents of the RRC message 410, or both. In other words, the UE 115-c may process (e.g., analyze) the RRC message 410 (e.g., RRC message 410 contents) and may determine an association between the RRC message 410 and one or more DUs 165 associated with the network entity 105 (e.g., and a configuration of an old cell group). Additionally, or alternatively (e.g., rather than processing the RRC message 410 to determine the association), the RRC message 410 may include an indication of the association between the RRC message 410 and the one or more DUs 165 (e.g., serving DUs 165, cell groups).

For example, the RRC message 410 may indicate a configuration associated with multiple DUs 165 associated with the network entity 105 (e.g., and the UE 115-c), including at least the DU 165-f (e.g., the RRC message 410 is generic). As such, the UE 115-c may apply the RRC message 410 (e.g., the UE 115-c should always apply generic RRC messages 410 independent of type of reception). In another example, the RRC message 410 may be associated with the DU 165-e, as such, the UE 115-c may discard (e.g., refrain from applying) the RRC message 410. In other words, the UE 115-c may refrain from applying RRC messages 410 associated with one or more other DUs 165 that are not a serving DU 165 (e.g., DUs 165 with which the UE 115-c is communicating) associated with the UE 115-c. In such cases, the UE 115-c may store a configuration indicated via the RRC message 410 and may apply the configuration based on resuming communications with the one or more other DUs 165 (e.g., apply the RRC message 410 to an old cell group configuration for subsequent LTM).

In some examples, the UE 115-c may apply a combination of the aforementioned techniques to determine whether to apply an RRC message 410 in a race condition. Alternatively, the UE 115-c may never apply RRC message 410 in a race condition (e.g., received “late”).

In some examples, the UE 115-c may transmit a feedback message 420 indicating whether the UE 115-c applied the RRC message 410 (e.g., the UE 115-c may notify the CU 160-c of RRC message 410 application). In some cases, the UE 115-c may refrain from applying (e.g., discard) an RRC message 410 (e.g., “late” RRC message 410). For example, the UE 115-c may receive the RRC message 410 within a threshold duration of receiving an LTM message 415, where the threshold duration is associated with a configuration of the UE 115-c, a processing duration associated with RRC messages 410, or both. In such cases, the UE 115-c may transmit a feedback message 420 indicating that the UE 115-c discarded the RRC message 410 (e.g., without declaring RLF). Alternatively, the UE 115-c may apply the RRC message 410 and may transmit a feedback message 420 (e.g., RRC response) indicating that UE 115-c applied the RRC message 410.

In some examples (e.g., if the UE 115-c has not performed the LTM cell switch procedure triggered via the LTM message 415), the UE 115-c may transmit the feedback message 420 to the CU 160-c via the DU 165-e. In some other examples (e.g., if the UE 115-c has performed the LTM switch procedure triggered via the LTM message 415), the UE 115-c may transmit the feedback message 420 to the CU 160-c via the DU 165-f. In some examples, the UE 115-c may receive an additional control message 405 indicating for the UE 115-c to transmit feedback messages 420 (e.g., indicating that the UE 115-c failed to apply RRC messages 410). In some examples, the additional control message 405 may be associated with an SRB, such that the UE 115-c transmits feedback messages 420 for RRC messages 410 associated with the SRB.

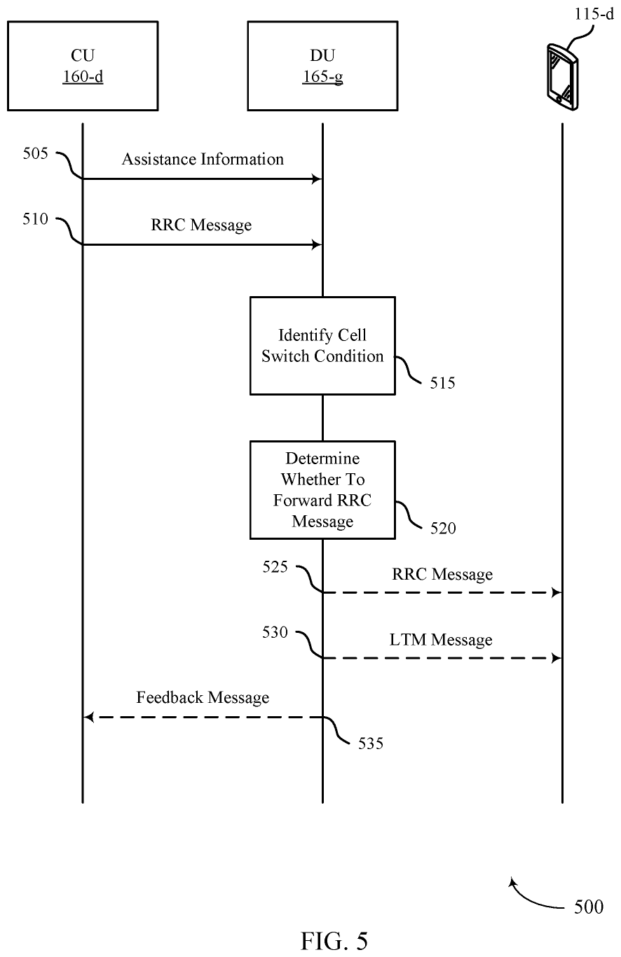

FIG. 5 illustrates an example of a process flow 500 that supports techniques for precedence between L3 reconfiguration and LTM execution in accordance with one or more aspects of the present disclosure. The process flow 500 may implement or be implemented by aspects of the wireless communications system 100, the network architecture 200, the wireless communications system 300, or the wireless communications system 400. For example, the process flow 500 may include one or more network entities 105 (e.g., a network entity 105 associated with a CU 160-d and a DU 165-g) and one or more UEs 115 (e.g., a UE 115-d), which may represent examples of corresponding devices as described with reference to FIG. 1. In some examples, the DU 165-g may support avoidance of a race condition based on determining whether to forward an RRC message.

At 505, the DU 165-g may receive a first control message including assistance information associated with a second control message, where the second control message may indicate a configuration associated with the UE 115-d. In some examples, the assistance information may be associated with the second control message (e.g., may be RRC message specific), a first type of control message (e.g., RRC message) further associated with the second control message, an SRB associated with the second control message, oy any combination thereof.

Additionally, or alternatively, the assistance information may include a duration associated with applying the second control message, a condition associated with forwarding the second control message, a precedence associated with forwarding the second control message, or any combination thereof. For example, the duration may be a processing duration associated with the second control message. Additionally, or alternatively, the condition may be based on a communication link between the UE 115-d and the DU 165-g. Additionally, or alternatively, the precedence may indicate whether the second control message is of higher priority than a control message indicating for the UE 115-d to perform a cell switch procedure.

At 510, the DU 165-g (e.g., a first cell of the network entity 105) may receive, from the CU 160-d, the second control message (e.g., RRC message) indicating the configuration associated with the UE 115-d. In some examples, the second control message may be contained in an additional control message (e.g., F1AP message). In some examples, the additional control message may include the assistance information associated with the first control message.

At 515, the DU 165-g may identify a condition associated with transmitting a third control message (e.g., LTM cell switch command, LTM message) indicating for the UE 115-d to perform a cell switch procedure to switch communications with the DU 165-g to another DU 165 (e.g., a second cell of the network entity 105).

At 520, the DU 165-g may determine whether to forward the second control message to the UE 115-d based on the condition, the assistance information, or both.

At 525, the DU 165-g may transmit the second control message based on one or more measurements associated with the communication link between the UE 115-d and the DU 165-g exceeding a threshold, where the condition is associated with the one or more measurements. In such cases, the DU 165-g may refrain from transmitting the third control message based on transmitting the second control message. Alternatively, the DU 165-g may transmit the third control message a threshold duration after transmitting the second control message, where the threshold duration is based on an application (e.g., processing time) of the second control message

At 530, the DU 165-g may transmit the third control message based on one or more measurements associated with the communication link between the UE 115-d and the DU 165-g failing to exceed the threshold, where the condition is associated with the one or more measurements. In such cases, the DU 165-g may refrain from transmitting (e.g., forwarding) the second control message based on transmitting the third control message.

At 535, the DU 165-g may transmit (e.g., via a feedback message) an indication that the DU 165-g refrained from forwarding the second control message, transmitted the third control message, or both.

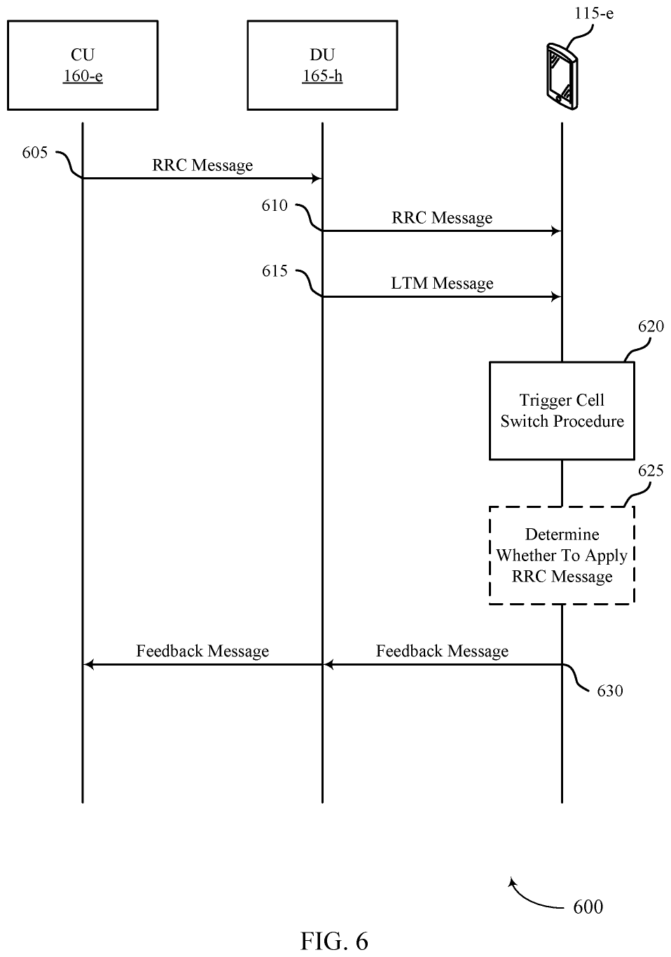

FIG. 6 illustrates an example of a process flow 600 that supports techniques for precedence between L3 reconfiguration and LTM execution in accordance with one or more aspects of the present disclosure. The process flow 600 may implement or be implemented by aspects of the wireless communications system 100, the wireless network architecture 200, the wireless communications system 300, the wireless communications system 400, or the process flow 500. For example, the process flow 600 may include one or more network entities 105 (e.g., a network entity 105 associated with a CU 160-e and a DU 165-h) and one or more UEs 115 (e.g., a UE 115-e), which may represent examples of corresponding devices as described with reference to FIG. 1. In some examples, the UE 115-e may support resolution of a race condition based on determining whether to apply an RRC message.

At 605, the DU 165-h (e.g., a first cell of the network entity 105) may receive, from the CU 160-e, a first control message (e.g., RRC message) indicating a configuration associated with the UE 115-d. In some examples, the first control message may be contained in an additional control message (e.g., F1AP message).

At 610, the DU 165-h may transmit (e.g., forward), to the UE 115-e, the first control message indicating the configuration associated with the UE 115-e.

At 615, the DU 165-h may transmit the second control message within a threshold duration of transmitting the first control message, where the threshold duration is based on an application time of the first control message. In some examples, the first control message and the second control message may be associated with (e.g., transmitted via) a same TB (e.g., transmitted together).

At 620, the UE 115-e may trigger the cell switch procedure to switch communications with the DU 165-h to another DU 165 of the network entity 105 based on receiving the second control message.

At 625, the UE 115-e may determine whether to apply the configuration associated with the first control message. In some examples, the UE 115-e may apply the configuration associated with the first control message based on the first control message being associated with a first type of control message. The first type of control message may be an RRC message.

Additionally, or alternatively, the UE 115-e may apply the configuration associated with the first control message based on a second configuration associated with the UE 115-e. For example, the second configuration may indicate for the UE 115-e to apply control messages associated with the first type of control message and the UE 115-e may apply the configuration associated with the first control message based on the first control message being associated with the first type of control message. In some other examples, the second configuration may indicate for the UE 115-e to apply the first control message. In some other examples, the second configuration may indicate for the UE 115-e to apply control messages associated with a first SRB and the UE 115-e may apply the configuration associated with the first control message based on the first control message being associated with the first SRB. Additionally, or alternatively, the second configuration may indicate a threshold duration, where a duration between applying the first control message and triggering the cell switch procedure satisfies the threshold duration.

Additionally, or alternatively, the UE 115-e may apply the configuration associated with the UE 115-e based on the contents of the configuration indicated via the first control message. For example, the configuration may be associated with multiple DUs 165 of the network entity, including at least the DU 165-h and the other DU 165. In some examples, the first control message may include an indication of the associated between the configuration and the multiple DUs 165.

Alternatively, the UE 115-e may refrain from applying the first control message. In some examples, the UE 115-e may refrain from applying (e.g., discard) the first control message based on the contents of the configuration indicated via the first control message. For example, the configuration may be associated with the DU 165-h. In some examples, the first control message may include an indication of the associated between the configuration and the multiple DUs 165. Additionally, or alternatively, the UE 115-e may refrain from applying the configuration associated with the first control message based on the first control message being received within the threshold duration of receipt of the second control message.

At 630, the UE 115-e may transmit, to the CU 160-e (e.g., via the DU 165-h or the other DU 165), an indication of whether the UE 115-e applied the configuration associated with the control message. For example, the UE 115-e may transmit the indication that the UE 115-e applied the configuration associated with the first control message. Alternatively, the UE 115-e may transmit the indication that the UE 115-e discarded the configuration associated with the first control message.

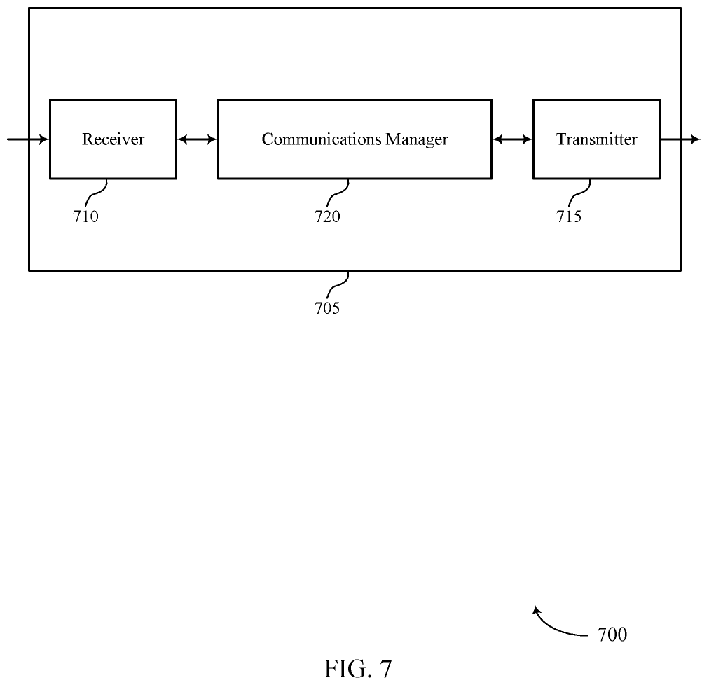

FIG. 7 illustrates a block diagram 700 of a device 705 that supports techniques for precedence between L3 reconfiguration and LTM execution in accordance with one or more aspects of the present disclosure. The device 705 may be an example of aspects of a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations thereof or various components thereof may be examples of means for performing various aspects of techniques for precedence between L3 reconfiguration and LTM execution as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first cell of a network entity in accordance with examples as disclosed herein. For example, the communications manager 720 may be configured as or otherwise support a means for receiving a first control message indicating a configuration associated with a UE. The communications manager 720 may be configured as or otherwise support a means for identifying a condition associated with transmitting a second control message indicating for the UE to perform a cell switch procedure to switch communications with the first cell to a second cell of the network entity. The communications manager 720 may be configured as or otherwise support a means for determining whether to forward the first control message to the UE based on the condition.

Additionally, or alternatively, the communications manager 720 may support wireless communications at a first cell of a network entity in accordance with examples as disclosed herein. For example, the communications manager 720 may be configured as or otherwise support a means for transmitting a first control message indicating assistance information associated with a second control message, where the second control message indicates a configuration associated with a UE, and where the assistance information is associated with a second cell of the network entity determining whether to forward the first control message. The communications manager 720 may be configured as or otherwise support a means for transmitting the second control message indicating the configuration associated with the UE based on transmitting the assistance information.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for avoiding or resolving a race condition at a UE which may result in reduced processing, reduced power consumption, and more efficient utilization of communication resources, among other advantages.

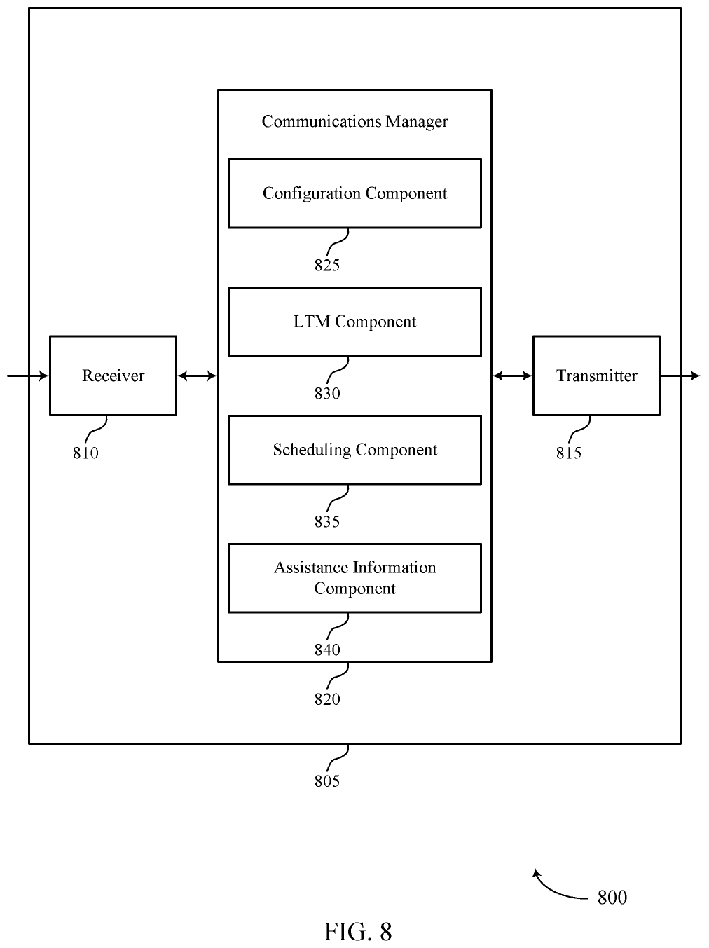

FIG. 8 illustrates a block diagram 800 of a device 805 that supports

techniques for precedence between L3 reconfiguration and LTM execution in accordance with one or more aspects of the present disclosure. The device 805 may be an example of aspects of a device 705 or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of techniques for precedence between L3 reconfiguration and LTM execution as described herein. For example, the communications manager 820 may include a configuration component 825, an LTM component 830, a scheduling component 835, an assistance information component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a first cell of a network entity in accordance with examples as disclosed herein. The configuration component 825 may be configured as or otherwise support a means for receiving a first control message indicating a configuration associated with a UE. The LTM component 830 may be configured as or otherwise support a means for identifying a condition associated with transmitting a second control message indicating for the UE to perform a cell switch procedure to switch communications with the first cell to a second cell of the network entity. The scheduling component 835 may be configured as or otherwise support a means for determining whether to forward the first control message to the UE based on the condition.

Additionally, or alternatively, the communications manager 820 may support wireless communications at a first cell of a network entity in accordance with examples as disclosed herein. The assistance information component 840 may be configured as or otherwise support a means for transmitting a first control message indicating assistance information associated with a second control message, where the second control message indicates a configuration associated with a UE, and where the assistance information is associated with a second cell of the network entity determining whether to forward the first control message. The configuration component 825 may be configured as or otherwise support a means for transmitting the second control message indicating the configuration associated with the UE based on transmitting the assistance information.

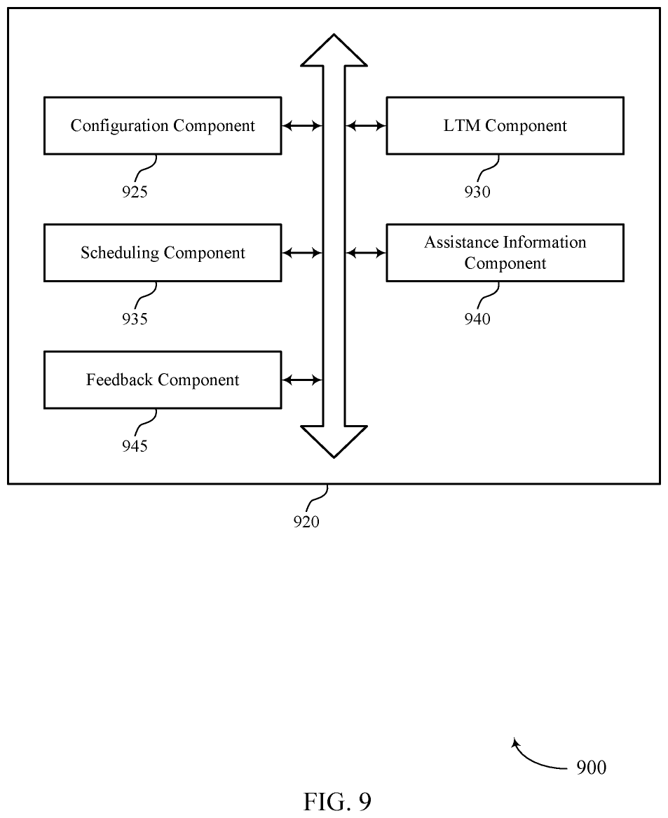

FIG. 9 illustrates a block diagram 900 of a communications manager 920 that supports techniques for precedence between L3 reconfiguration and LTM execution in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for precedence between L3 reconfiguration and LTM execution as described herein. For example, the communications manager 920 may include a configuration component 925, an LTM component 930, a scheduling component 935, an assistance information component 940, a feedback component 945, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The configuration component 925, the LTM component 930, the scheduling component 935, the assistance information component 940, the feedback component 945, and/or at least some of their respective sub-components may be implemented in hardware, software executed by a processor, firmware, or any combination thereof. If implemented in software executed by a processor, the functions of the configuration component 925, the LTM component 930, the scheduling component 935, the assistance information component 940, the feedback component 945, and/or at least some of their respective sub-components may be executed by a general-purpose processor, a DSP, an ASIC, an FPGA or other programmable logic device, discrete gate or transistor logic, discrete hardware components, or any combination thereof designed to perform the functions described in the present disclosure. The configuration component 925, the LTM component 930, the scheduling component 935, the assistance information component 940, the feedback component 945, and/or at least some of their respective sub-components may be physically located at various positions, including being distributed such that portions of functions are implemented at different physical locations by one or more physical devices. In some examples, the configuration component 925, the LTM component 930, the scheduling component 935, the assistance information component 940, the feedback component 945, and/or at least some of their respective sub-components may be a separate and distinct component in accordance with various aspects of the present disclosure. In other examples, the configuration component 925, the LTM component 930, the scheduling component 935, the assistance information component 940, the feedback component 945, and/or at least some of their respective sub-components may be combined with one or more other hardware components, including but not limited to a receiver, a transmitter, a transceiver, one or more other components described in the present disclosure, or a combination thereof in accordance with various aspects of the present disclosure.

The communications manager 920 may support wireless communications at a first cell of a network entity in accordance with examples as disclosed herein. The configuration component 925 may be configured as or otherwise support a means for receiving a first control message indicating a configuration associated with a UE. The LTM component 930 may be configured as or otherwise support a means for identifying a condition associated with transmitting a second control message indicating for the UE to perform a cell switch procedure to switch communications with the first cell to a second cell of the network entity. The scheduling component 935 may be configured as or otherwise support a means for determining whether to forward the first control message to the UE based on the condition.

In some examples, the first cell is associated with a first DU of the network entity and the second cell is associated with a second DU of the network entity.

In some examples, the scheduling component 935 may be configured as or otherwise support a means for receiving assistance information associated with the first control message, where determining whether to forward the first control message is based on the assistance information.

In some examples, the first control message or a third control message include the assistance information.

In some examples, the assistance information includes a duration associated with applying the first control message, a condition associated with forwarding the first control message, a precedence associated with forwarding the first control message, or any combination thereof.

In some examples, the assistance information is associated with the first control message, a first type of control message associated with the first control message, an SRB associated with the first control message, or any combination thereof.

In some examples, the configuration component 925 may be configured as or otherwise support a means for transmitting the first control message based on one or more measurements associated with a communication link with the first cell exceeding a threshold, where the condition is associated with the one or more measurements.

In some examples, the scheduling component 935 may be configured as or otherwise support a means for refraining from transmitting the second control message based on transmitting the first control message.

In some examples, the LTM component 930 may be configured as or otherwise support a means for transmitting the second control message a threshold duration after transmitting the first control message, where the threshold duration is based on an application time of the first control message.

In some examples, the LTM component 930 may be configured as or otherwise support a means for transmitting the second control message based on one or more measurements associated with a communication link with the first cell failing to exceed a threshold, where the condition is associated with the one or more measurements.

In some examples, the scheduling component 935 may be configured as or otherwise support a means for refraining from forwarding the first control message based on transmitting the second control message.

In some examples, the feedback component 945 may be configured as or otherwise support a means for transmitting an indication that the first cell refrained from forwarding the first control message, transmitted the second control message, or both.

In some examples, the configuration component 925 may be configured as or otherwise support a means for transmitting the first control message. In some examples, the LTM component 930 may be configured as or otherwise support a means for transmitting the second control message within a threshold duration of transmitting the first control message, where the threshold duration is based on an application time of the first control message.

In some examples, the first control message and the second control message are associated with a same TB.

Additionally, or alternatively, the communications manager 920 may support wireless communications at a first cell of a network entity in accordance with examples as disclosed herein. The assistance information component 940 may be configured as or otherwise support a means for transmitting a first control message indicating assistance information associated with a second control message, where the second control message indicates a configuration associated with a UE, and where the assistance information is associated with a second cell of the network entity determining whether to forward the first control message. In some examples, the configuration component 925 may be configured as or otherwise support a means for transmitting the second control message indicating the configuration associated with the UE based on transmitting the assistance information.

In some examples, the assistance information includes a duration associated with applying the second control message, a condition associated with forwarding the second control message, a precedence associated with forwarding the second control message, or any combination thereof.

In some examples, the assistance information is associated with the second control message, a first type of control message associated with the second control message, an SRB associated with the second control message, or any combination thereof.

In some examples, the first control message and the second control message are a same control message.

In some examples, the feedback component 945 may be configured as or otherwise support a means for receiving an indication that the second cell refrained from forwarding the second control message, transmitted a third control message indicating for the UE to perform a cell switch procedure, or both.

In some examples, the feedback component 945 may be configured as or otherwise support a means for receiving an indication that the UE applied the second control message or discarded the second control message.

In some examples, the first cell is a CU of the network entity and the second cell is a DU of the network entity.

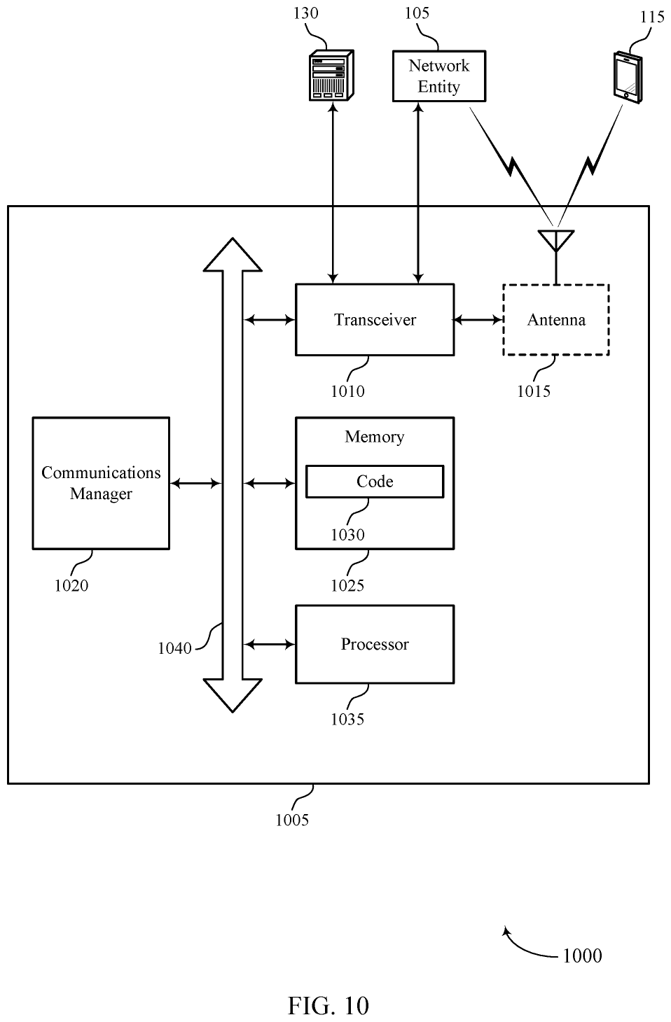

FIG. 10 illustrates a diagram of a system 1000 including a device 1005 that supports techniques for precedence between L3 reconfiguration and LTM execution in accordance with one or more aspects of the present disclosure. The device 1005 may be an example of or include the components of a device 705, a device 805, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, a memory 1025, code 1030, and a processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or memory components (for example, the processor 1035, or the memory 1025, or both), may be included in a chip or chip assembly that is installed in the device 1005. In some examples, the transceiver may be operable to support communications via one or more communications links (e.g., a communication link 125, a backhaul communication link 120, a midhaul communication link 162, a fronthaul communication link 168).

The memory 1025 may include RAM and ROM. The memory 1025 may store computer-readable, computer-executable code 1030 including instructions that, when executed by the processor 1035, cause the device 1005 to perform various functions described herein. The code 1030 may be stored in a non-transitory computer-readable medium such as system memory or another type of memory. In some cases, the code 1030 may not be directly executable by the processor 1035 but may cause a computer (e.g., when compiled and executed) to perform functions described herein. In some cases, the memory 1025 may contain, among other things, a BIOS which may control basic hardware or software operation such as the interaction with peripheral components or devices.

The processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1035 may be configured to operate a memory array using a memory controller. In some other cases, a memory controller may be integrated into the processor 1035. The processor 1035 may be configured to execute computer-readable instructions stored in a memory (e.g., the memory 1025) to cause the device 1005 to perform various functions (e.g., functions or tasks supporting techniques for precedence between L3 reconfiguration and LTM execution). For example, the device 1005 or a component of the device 1005 may include a processor 1035 and memory 1025 coupled with the processor 1035, the processor 1035 and memory 1025 configured to perform various functions described herein. The processor 1035 may be an example of a cloud-computing platform (e.g., one or more physical nodes and supporting software such as operating systems, virtual machines, or container instances) that may host the functions (e.g., by executing code 1030) to perform the functions of the device 1005. The processor 1035 may be any one or more suitable processors capable of executing scripts or instructions of one or more software programs stored in the device 1005 (such as within the memory 1025). In some implementations, the processor 1035 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1035, or the transceiver 1010, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the memory 1025, the code 1030, and the processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communications at a first cell of a network entity in accordance with examples as disclosed herein. For example, the communications manager 1020 may be configured as or otherwise support a means for receiving a first control message indicating a configuration associated with a UE. The communications manager 1020 may be configured as or otherwise support a means for identifying a condition associated with transmitting a second control message indicating for the UE to perform a cell switch procedure to switch communications with the first cell to a second cell of the network entity. The communications manager 1020 may be configured as or otherwise support a means for determining whether to forward the first control message to the UE based on the condition.

Additionally, or alternatively, the communications manager 1020 may support wireless communications at a first cell of a network entity in accordance with examples as disclosed herein. For example, the communications manager 1020 may be configured as or otherwise support a means for transmitting a first control message indicating assistance information associated with a second control message, where the second control message indicates a configuration associated with a UE, and where the assistance information is associated with a second cell of the network entity determining whether to forward the first control message. The communications manager 1020 may be configured as or otherwise support a means for transmitting the second control message indicating the configuration associated with the UE based on transmitting the assistance information.

By including or configuring the communications manager 1020 in accordance with examples as described herein, the device 1005 may support techniques for avoiding or resolving a race condition at a UE which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, the processor 1035, the memory 1025, the code 1030, or any combination thereof. For example, the code 1030 may include instructions executable by the processor 1035 to cause the device 1005 to perform various aspects of techniques for precedence between L3 reconfiguration and LTM execution as described herein, or the processor 1035 and the memory 1025 may be otherwise configured to perform or support such operations.

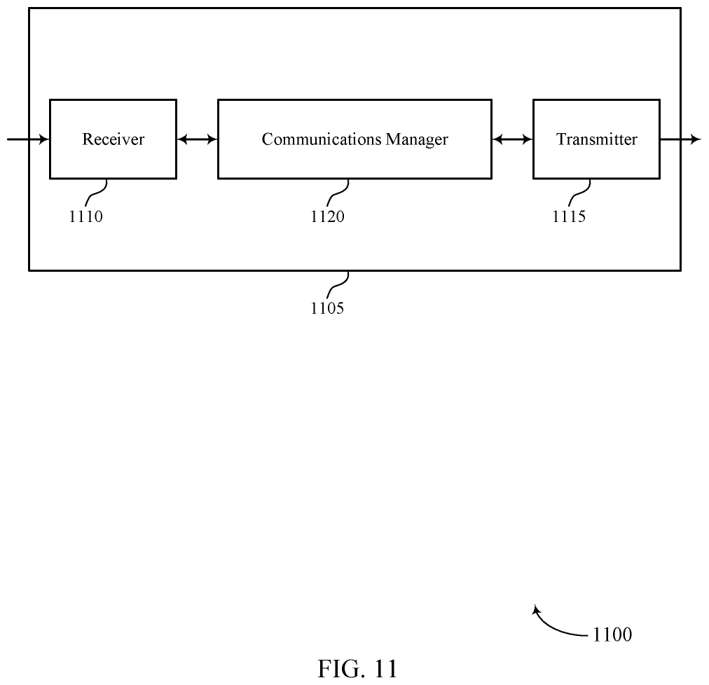

FIG. 11 illustrates a block diagram 1100 of a device 1105 that supports techniques for precedence between L3 reconfiguration and LTM execution in accordance with one or more aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for precedence between L3 reconfiguration and LTM execution). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for precedence between L3 reconfiguration and LTM execution). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of techniques for precedence between L3 reconfiguration and LTM execution as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a UE in accordance with examples as disclosed herein. For example, the communications manager 1120 may be configured as or otherwise support a means for receiving, from a first cell of a network entity, a first control message indicating a configuration associated with the UE. The communications manager 1120 may be configured as or otherwise support a means for receiving, from the first cell, a second control message indicating for the UE to perform a cell switch procedure, where the second control message is received within a threshold duration of receipt of the first control message. The communications manager 1120 may be configured as or otherwise support a means for triggering the cell switch procedure to switch communications with the first cell to a second cell of the network entity based on receiving the second control message. The communications manager 1120 may be configured as or otherwise support a means for transmitting an indication of whether the UE applied the configuration associated with the first control message.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for avoiding or resolving a race condition at a UE which may result in reduced processing, reduced power consumption, and more efficient utilization of communication resource, among other advantages.

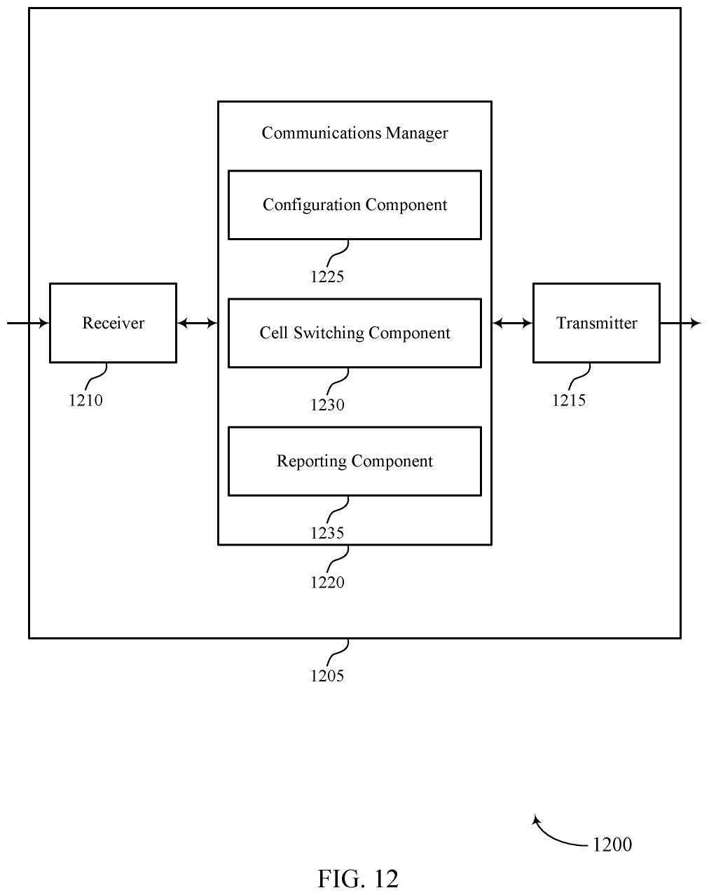

FIG. 12 illustrates a block diagram 1200 of a device 1205 that supports techniques for precedence between L3 reconfiguration and LTM execution in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for precedence between L3 reconfiguration and LTM execution). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for precedence between L3 reconfiguration and LTM execution). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of techniques for precedence between L3 reconfiguration and LTM execution as described herein. For example, the communications manager 1220 may include a configuration component 1225, a cell switching component 1230, a reporting component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a UE in accordance with examples as disclosed herein. The configuration component 1225 may be configured as or otherwise support a means for receiving, from a first cell of a network entity, a first control message indicating a configuration associated with the UE. The cell switching component 1230 may be configured as or otherwise support a means for receiving, from the first cell, a second control message indicating for the UE to perform a cell switch procedure, where the second control message is received within a threshold duration of receipt of the first control message. The cell switching component 1230 may be configured as or otherwise support a means for triggering the cell switch procedure to switch communications with the first cell to a second cell of the network entity based on receiving the second control message. The reporting component 1235 may be configured as or otherwise support a means for transmitting an indication of whether the UE applied the configuration associated with the first control message.

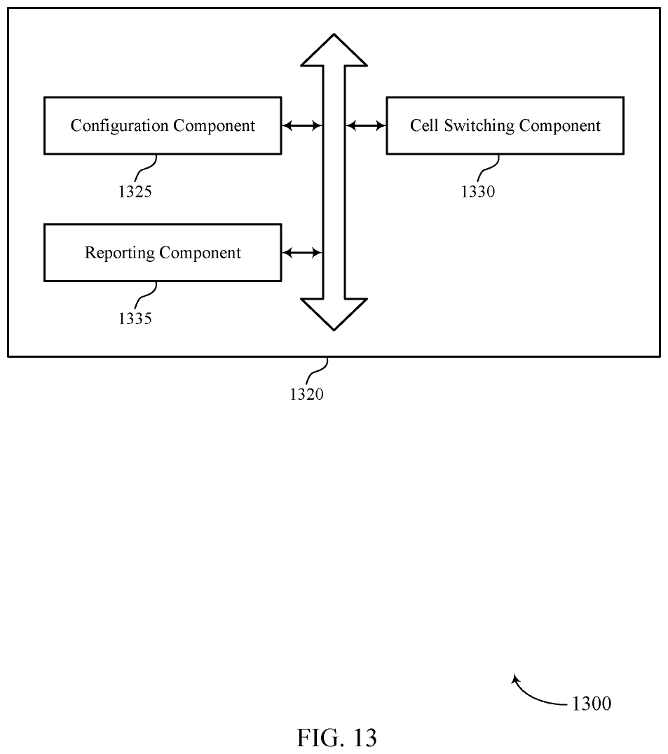

FIG. 13 illustrates a block diagram 1300 of a communications manager 1320 that supports techniques for precedence between L3 reconfiguration and LTM execution in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for precedence between L3 reconfiguration and LTM execution as described herein. For example, the communications manager 1320 may include a configuration component 1325, a cell switching component 1330, a reporting component 1335, or any combination thereof. Each of these components may communicate, directly or indirectly, with one another (e.g., via one or more buses).

The configuration component 1325, the cell switching component 1330, the reporting component 1335, and/or at least some of their respective sub-components may be implemented in hardware, software executed by a processor, firmware, or any combination thereof. If implemented in software executed by a processor, the functions of the configuration component 1325, the cell switching component 1330, the reporting component 1335, and/or at least some of their respective sub-components may be executed by a general-purpose processor, a DSP, an ASIC, an FPGA or other programmable logic device, discrete gate or transistor logic, discrete hardware components, or any combination thereof designed to perform the functions described in the present disclosure. The configuration component 1325, the cell switching component 1330, the reporting component 1335, and/or at least some of their respective sub-components may be physically located at various positions, including being distributed such that portions of functions are implemented at different physical locations by one or more physical devices. In some examples, the configuration component 1325, the cell switching component 1330, the reporting component 1335, and/or at least some of their respective sub-components may be a separate and distinct component in accordance with various aspects of the present disclosure. In other examples, the configuration component 1325, the cell switching component 1330, the reporting component 1335, and/or at least some of their respective sub-components may be combined with one or more other hardware components, including but not limited to a receiver, a transmitter, a transceiver, one or more other components described in the present disclosure, or a combination thereof in accordance with various aspects of the present disclosure.

The communications manager 1320 may support wireless communications at a UE in accordance with examples as disclosed herein. The configuration component 1325 may be configured as or otherwise support a means for receiving, from a first cell of a network entity, a first control message indicating a configuration associated with the UE. The cell switching component 1330 may be configured as or otherwise support a means for receiving, from the first cell, a second control message indicating for the UE to perform a cell switch procedure, where the second control message is received within a threshold duration of receipt of the first control message. In some examples, the cell switching component 1330 may be configured as or otherwise support a means for triggering the cell switch procedure to switch communications with the first cell to a second cell of the network entity based on receiving the second control message. The reporting component 1335 may be configured as or otherwise support a means for transmitting an indication of whether the UE applied the configuration associated with the first control message.

In some examples, the UE transmits the indication that the UE applied the configuration associated with the first control message.

In some examples, the configuration component 1325 may be configured as or otherwise support a means for applying the configuration associated with the first control message based on the first control message being associated with a first type of control message.

In some examples, the first type of control message is a RRC message.

In some examples, the configuration component 1325 may be configured as or otherwise support a means for applying the configuration associated with the first control message based at least in part a second configuration associated with the UE.

In some examples, the second configuration indicates for the UE to apply control messages associated with a first type of control message, and the first control message is associated with the first type of control message.

In some examples, the second configuration indicates for the UE to apply the first control message.

In some examples, the second configuration indicates for the UE to apply control messages associated with a first SRB. In some examples, the first control message is associated with the first SRB.

In some examples, the second configuration indicates a threshold duration. In some examples, a duration between applying the first control message and triggering the cell switch procedure satisfies the threshold duration.

In some examples, the configuration component 1325 may be configured as or otherwise support a means for applying the configuration associated with the UE based on the configuration indicated via the first control message.

In some examples, the configuration is associated with a set of multiple cells of the network entity, the set of multiple cells including at least the first cell and the second cell.

In some examples, the first control message includes an indication of the association between the configuration and the set of multiple cells.

In some examples, the UE transmits the indication that the UE discarded the configuration associated with the first control message.

In some examples, the configuration component 1325 may be configured as or otherwise support a means for discarding the configuration associated with the UE based on the configuration indicated via the first control message.

In some examples, the configuration is associated with the first cell of the network entity.

In some examples, the first control message includes an indication of the association between the configuration and the first cell.

In some examples, the cell switching component 1330 may be configured as or otherwise support a means for discarding the configuration associated with the first control message based on the first control message being received within the threshold duration of receipt of the second control message.

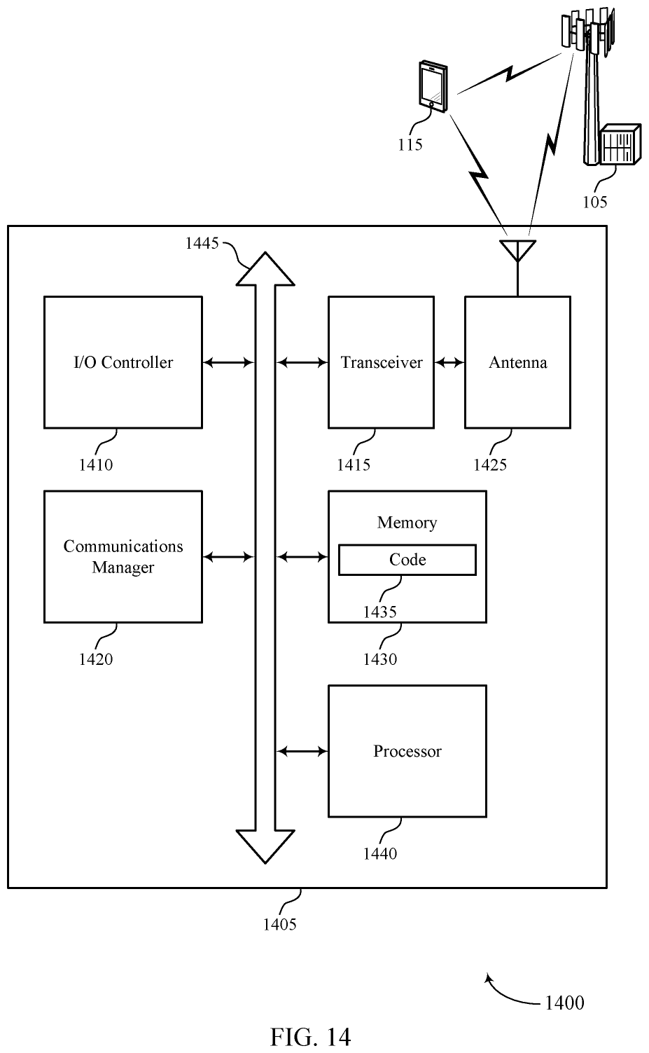

FIG. 14 illustrates a diagram of a system 1400 including a device 1405 that supports techniques for precedence between L3 reconfiguration and LTM execution in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting techniques for precedence between L3 reconfiguration and LTM execution). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communications at a UE in accordance with examples as disclosed herein. For example, the communications manager 1420 may be configured as or otherwise support a means for receiving, from a first cell of a network entity, a first control message indicating a configuration associated with the UE. The communications manager 1420 may be configured as or otherwise support a means for receiving, from the first cell, a second control message indicating for the UE to perform a cell switch procedure, where the second control message is received within a threshold duration of receipt of the first control message. The communications manager 1420 may be configured as or otherwise support a means for triggering the cell switch procedure to switch communications with the first cell to a second cell of the network entity based on receiving the second control message. The communications manager 1420 may be configured as or otherwise support a means for transmitting an indication of whether the UE applied the configuration associated with the first control message.

By including or configuring the communications manager 1420 in accordance with examples as described herein, the device 1405 may support techniques for avoiding or resolving a race condition at a UE which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of techniques for precedence between L3 reconfiguration and LTM execution as described herein, or the processor 1440 and the memory 1430 may be otherwise configured to perform or support such operations.

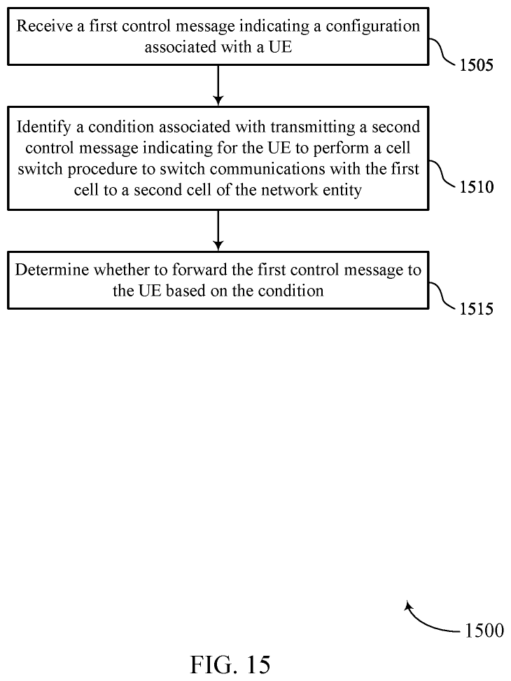

FIG. 15 illustrates a flowchart showing a method 1500 that supports techniques for precedence between L3 reconfiguration and LTM execution in accordance with one or more aspects of the present disclosure. The operations of the method 1500 may be implemented by a network entity or its components as described herein. For example, the operations of the method 1500 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1505, the method may include receiving a first control message indicating a configuration associated with a UE. The operations of 1505 may be performed in accordance with examples as disclosed herein. In some examples, aspects of the operations of 1505 may be performed by a configuration component 925 as described with reference to FIG. 9.

At 1510, the method may include identifying a condition associated with transmitting a second control message indicating for the UE to perform a cell switch procedure to switch communications with the first cell to a second cell of the network entity. The operations of 1510 may be performed in accordance with examples as disclosed herein. In some examples, aspects of the operations of 1510 may be performed by an LTM component 930 as described with reference to FIG. 9.

At 1515, the method may include determining whether to forward the first control message to the UE based on the condition. The operations of 1515 may be performed in accordance with examples as disclosed herein. In some examples, aspects of the operations of 1515 may be performed by a scheduling component 935 as described with reference to FIG. 9.

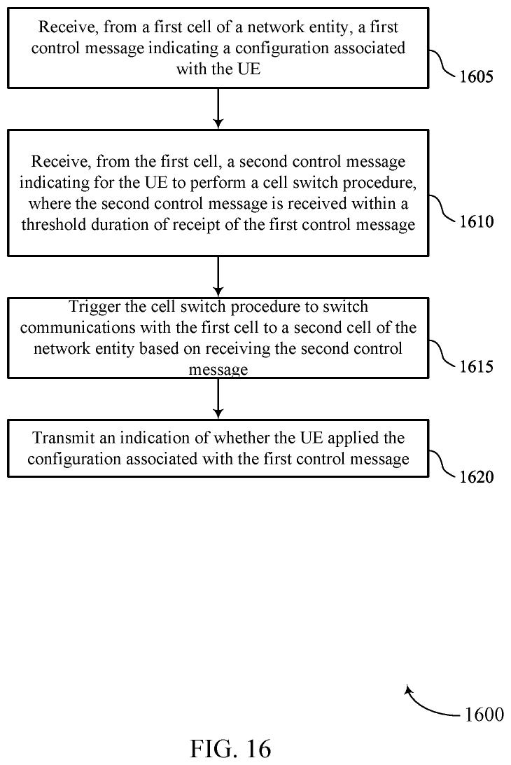

FIG. 16 illustrates a flowchart showing a method 1600 that supports techniques for precedence between L3 reconfiguration and LTM execution in accordance with one or more aspects of the present disclosure. The operations of the method 1600 may be implemented by a UE or its components as described herein. For example, the operations of the method 1600 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1605, the method may include receiving, from a first cell of a network entity, a first control message indicating a configuration associated with the UE. The operations of 1605 may be performed in accordance with examples as disclosed herein. In some examples, aspects of the operations of 1605 may be performed by a configuration component 1325 as described with reference to FIG. 13.

At 1610, the method may include receiving, from the first cell, a second control message indicating for the UE to perform a cell switch procedure, where the second control message is received within a threshold duration of receipt of the first control message. The operations of 1610 may be performed in accordance with examples as disclosed herein. In some examples, aspects of the operations of 1610 may be performed by a cell switching component 1330 as described with reference to FIG. 13.

At 1615, the method may include triggering the cell switch procedure to switch communications with the first cell to a second cell of the network entity based on receiving the second control message. The operations of 1615 may be performed in accordance with examples as disclosed herein. In some examples, aspects of the operations of 1615 may be performed by a cell switching component 1330 as described with reference to FIG. 13.

At 1620, the method may include transmitting an indication of whether the UE applied the configuration associated with the first control message. The operations of 1620 may be performed in accordance with examples as disclosed herein. In some examples, aspects of the operations of 1620 may be performed by a reporting component 1335 as described with reference to FIG. 13.

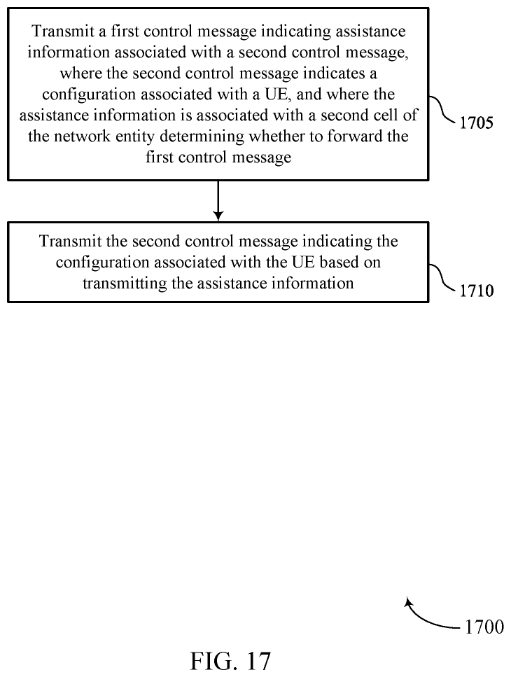

FIG. 17 illustrates a flowchart showing a method 1700 that supports techniques for precedence between L3 reconfiguration and LTM execution in accordance with one or more aspects of the present disclosure. The operations of the method 1700 may be implemented by a network entity or its components as described herein. For example, the operations of the method 1700 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a first control message indicating assistance information associated with a second control message, where the second control message indicates a configuration associated with a UE, and where the assistance information is associated with a second cell of the network entity determining whether to forward the first control message. The operations of 1705 may be performed in accordance with examples as disclosed herein. In some examples, aspects of the operations of 1705 may be performed by an assistance information component 940 as described with reference to FIG. 9.

At 1710, the method may include transmitting the second control message indicating the configuration associated with the UE based on transmitting the assistance information. The operations of 1710 may be performed in accordance with examples as disclosed herein. In some examples, aspects of the operations of 1710 may be performed by a configuration component 925 as described with reference to FIG. 9.

The following provides an overview of aspects of the present disclosure:
Aspect 1: A method for wireless communications at a first cell of a network entity, comprising: receiving a first control message indicating a configuration associated with a UE; identifying a condition associated with transmitting a second control message indicating for the UE to perform a cell switch procedure to switch communications with the first cell to a second cell of the network entity; and determining whether to forward the first control message to the UE based at least in part on the condition.
Aspect 2: The method of aspect 1, wherein the first cell is associated with a first DU of the network entity and the second cell is associated with a second DU of the network entity.
Aspect 3: The method of any of aspects 1 through 2, further comprising: receiving assistance information associated with the first control message, wherein determining whether to forward the first control message is based at least in part on the assistance information.
Aspect 4: The method of aspect 3, wherein the first control message or a third control message comprise the assistance information.
Aspect 5: The method of any of aspects 3 through 4, wherein the assistance information comprises a duration associated with applying the first control message, a condition associated with forwarding the first control message, a precedence associated with forwarding the first control message, or any combination thereof.
Aspect 6: The method of any of aspects 3 through 5, wherein the assistance information is associated with the first control message, a first type of control message associated with the first control message, a SRB associated with the first control message, or any combination thereof.
Aspect 7: The method of any of aspects 1 through 6, further comprising: transmitting the first control message based at least in part on one or more measurements associated with a communication link with the first cell exceeding a threshold, wherein the condition is associated with the one or more measurements.
Aspect 8: The method of aspect 7, further comprising: refraining from transmitting the second control message based at least in part on transmitting the first control message.
Aspect 9: The method of aspect 7, further comprising: transmitting the second control message a threshold duration after transmitting the first control message, wherein the threshold duration is based at least in part on an application time of the first control message.
Aspect 10: The method of any of aspects 1 through 6, further comprising: transmitting the second control message based at least in part on one or more measurements associated with a communication link with the first cell failing to exceed a threshold, wherein the condition is associated with the one or more measurements.
Aspect 11: The method of aspect 10, further comprising: refraining from forwarding the first control message based at least in part on transmitting the second control message.
Aspect 12: The method of aspect 11, further comprising: transmitting an indication that the first cell refrained from forwarding the first control message, transmitted the second control message, or both.
Aspect 13: The method of any of aspects 1 through 6, further comprising: transmitting the first control message; and transmitting the second control message within a threshold duration of transmitting the first control message, wherein the threshold duration is based at least in part on an application time of the first control message.
Aspect 14: The method of aspect 13, wherein the first control message and the second control message are associated with a same TB.
Aspect 15: A method for wireless communications at a UE, comprising: receiving, from a first cell of a network entity, a first control message indicating a configuration associated with the UE; receiving, from the first cell, a second control message indicating for the UE to perform a cell switch procedure, wherein the second control message is received within a threshold duration of receipt of the first control message; triggering the cell switch procedure to switch communications with the first cell to a second cell of the network entity based at least in part on receiving the second control message; and transmitting an indication of whether the UE applied the configuration associated with the first control message.
Aspect 16: The method of aspect 15, wherein the UE transmits the indication that the UE applied the configuration associated with the first control message.
Aspect 17: The method of aspect 16, further comprising: applying the configuration associated with the first control message based at least in part on the first control message being associated with a first type of control message.
Aspect 18: The method of aspect 17, wherein the first type of control message is a RRC message.
Aspect 19: The method of any of aspects 16 through 18, further comprising: applying the configuration associated with the first control message based at least in part a second configuration associated with the UE.
Aspect 20: The method of aspect 19, wherein the second configuration indicates for the UE to apply control messages associated with a first type of control message, and the first control message is associated with the first type of control message.
Aspect 21: The method of any of aspects 19 through 20, wherein the second configuration indicates for the UE to apply the first control message.
Aspect 22: The method of any of aspects 19 through 21, wherein the second configuration indicates for the UE to apply control messages associated with a first SRB, and the first control message is associated with the first SRB.
Aspect 23: The method of any of aspects 19 through 22, wherein the second configuration indicates a threshold duration, and a duration between applying the first control message and triggering the cell switch procedure satisfies the threshold duration.
Aspect 24: The method of any of aspects 16 through 23, further comprising: applying the configuration associated with the UE based at least in part on the configuration indicated via the first control message.
Aspect 25: The method of aspect 24, wherein the configuration is associated with a plurality of cells of the network entity, the plurality of cells including at least the first cell and the second cell.
Aspect 26: The method of aspect 25, wherein the first control message comprises an indication of the association between the configuration and the plurality of cells.
Aspect 27: The method of aspect 15, wherein the UE transmits the indication that the UE discarded the configuration associated with the first control message.
Aspect 28: The method of aspect 27, further comprising: discarding the configuration associated with the UE based at least in part on the configuration indicated via the first control message.
Aspect 29: The method of aspect 28, wherein the configuration is associated with the first cell of the network entity.
Aspect 30: The method of aspect 29, wherein the first control message comprises an indication of the association between the configuration and the first cell.
Aspect 31: The method of any of aspects 27 through 30, further comprising: discarding the configuration associated with the first control message based at least in part on the first control message being received within the threshold duration of receipt of the second control message.
Aspect 32: A method for wireless communications at a first cell of a network entity, comprising: transmitting a first control message indicating assistance information associated with a second control message, wherein the second control message indicates a configuration associated with a UE, and wherein the assistance information is associated with a second cell of the network entity determining whether to forward the first control message; and transmitting the second control message indicating the configuration associated with the UE based at least in part on transmitting the assistance information.
Aspect 33: The method of aspect 32, wherein the assistance information comprises a duration associated with applying the second control message, a condition associated with forwarding the second control message, a precedence associated with forwarding the second control message, or any combination thereof.
Aspect 34: The method of any of aspects 32 through 33, wherein the assistance information is associated with the second control message, a first type of control message associated with the second control message, a SRB associated with the second control message, or any combination thereof.
Aspect 35: The method of any of aspects 32 through 34, wherein the first control message and the second control message are a same control message.
Aspect 36: The method of any of aspects 32 through 35, further comprising: receiving an indication that the second cell refrained from forwarding the second control message, transmitted a third control message indicating for the UE to perform a cell switch procedure, or both.
Aspect 37: The method of any of aspects 32 through 35, further comprising: receiving an indication that the UE applied the second control message or discarded the second control message.
Aspect 38: The method of any of aspects 32 through 37, wherein the first cell is a CU of the network entity and the second cell is a DU of the network entity.
Aspect 39: An apparatus for wireless communications at a first cell of a network entity, comprising a processor; memory coupled with the processor; and instructions stored in the memory and executable by the processor to cause the apparatus to perform a method of any of aspects 1 through 14.
Aspect 40: An apparatus for wireless communications at a first cell of a network entity, comprising at least one means for performing a method of any of aspects 1 through 14.
Aspect 41: A non-transitory computer-readable medium storing code for wireless communications at a first cell of a network entity, the code comprising instructions executable by a processor to perform a method of any of aspects 1 through 14.
Aspect 42: An apparatus for wireless communications at a UE, comprising a processor; memory coupled with the processor; and instructions stored in the memory and executable by the processor to cause the apparatus to perform a method of any of aspects 15 through 31.
Aspect 43: An apparatus for wireless communications at a UE, comprising at least one means for performing a method of any of aspects 15 through 31.
Aspect 44: A non-transitory computer-readable medium storing code for wireless communications at a UE, the code comprising instructions executable by a processor to perform a method of any of aspects 15 through 31.
Aspect 45: An apparatus for wireless communications at a first cell of a network entity, comprising a processor; memory coupled with the processor; and instructions stored in the memory and executable by the processor to cause the apparatus to perform a method of any of aspects 32 through 38.
Aspect 46: An apparatus for wireless communications at a first cell of a network entity, comprising at least one means for performing a method of any of aspects 32 through 38.
Aspect 47: A non-transitory computer-readable medium storing code for wireless communications at a first cell of a network entity, the code comprising instructions executable by a processor to perform a method of any of aspects 32 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first cell of a network entity, comprising:
one or more processors;
one or more memories coupled with the one or more processors; and
instructions stored in the one or more memories and executable by the one or more processors to cause the apparatus to:
receive a first control message indicating a configuration associated with a user equipment (UE);
identify a condition associated with transmitting a second control message indicating for the UE to perform a cell switch procedure to switch communications with the first cell to a second cell of the network entity; and
determine whether to forward the first control message to the UE based at least in part on the condition.

2. The apparatus of claim 1, wherein the instructions are further executable by the one or more processors to cause the apparatus to:
transmitting the second control message based at least in part on receiving the first control message within a threshold duration of transmitting of the second control message.

3. The apparatus of claim 2, wherein the instructions are further executable by the one or more processors to cause the apparatus to:
refraining from forwarding the first control message based at least in part on transmitting the second control message.

4. The apparatus of claim 3, wherein the instructions are further executable by the one or more processors to cause the apparatus to:
transmitting an indication that the first cell refrained from forwarding the first control message.

5. The apparatus of claim 1, wherein the first control message is a radio resource control (RRC) message, and wherein the second control message is a layer 1 (L1)/layer 2 (L2) triggered mobility (LTM) message.

6. The apparatus of claim 1, wherein the first cell is associated with a first distributed unit of the network entity and the second cell is associated with a second distributed unit of the network entity.

7. The apparatus of claim 1, wherein the instructions are further executable by the one or more processors to cause the apparatus to:
transmit the first control message based at least in part on one or more measurements associated with a communication link with the first cell exceeding a threshold, wherein the condition is associated with the one or more measurements.

8. The apparatus of claim 7, wherein the instructions are further executable by the one or more processors to cause the apparatus to:
refrain from transmitting the second control message based at least in part on transmitting the first control message.

9. The apparatus of claim 7, wherein the instructions are further executable by the one or more processors to cause the apparatus to:
transmit the second control message a threshold duration after transmitting the first control message, wherein the threshold duration is based at least in part on an application time of the first control message.

10. The apparatus of claim 1, wherein the instructions are further executable by the one or more processors to cause the apparatus to:
transmit the first control message; and
transmit the second control message within a threshold duration of transmitting the first control message, wherein the threshold duration is based at least in part on an application time of the first control message.

11. The apparatus of claim 10, wherein the first control message and the second control message are associated with a same transport block.

12. An apparatus for wireless communications at a user equipment (UE), comprising:
one or more processors;
one or more memories coupled with the one or more processors; and
instructions stored in the one or more memories and executable by the one or more processors to cause the apparatus to:
receive, from a first cell of a network entity, a first control message indicating a configuration associated with the UE;
receive, from the first cell, a second control message indicating for the UE to perform a cell switch procedure, wherein the second control message is received within a threshold duration of receipt of the first control message;
trigger the cell switch procedure to switch communications with the first cell to a second cell of the network entity based at least in part on receiving the second control message; and
transmit an indication of whether the UE applied the configuration associated with the first control message.

13. The apparatus of claim 12, wherein the UE transmits the indication that the UE applied the configuration associated with the first control message.

14. The apparatus of claim 13, wherein the instructions are further executable by the one or more processors to cause the apparatus to:
apply the configuration associated with the first control message based at least in part on the first control message being associated with a first type of control message.

15. The apparatus of claim 14, wherein the first type of control message is a radio resource control message.

16. The apparatus of claim 13, wherein the instructions are further executable by the one or more processors to cause the apparatus to:
apply the configuration associated with the first control message based at least in part a second configuration associated with the UE.

17. The apparatus of claim 16, wherein the second configuration indicates for the UE to apply control messages associated with a first type of control message, and the first control message is associated with the first type of control message.

18. The apparatus of claim 16, wherein the second configuration indicates for the UE to apply the first control message.

19. The apparatus of claim 16, wherein the second configuration indicates for the UE to apply control messages associated with a first signaling radio bearer, and wherein the first control message is associated with the first signaling radio bearer.

20. The apparatus of claim 16, wherein the second configuration indicates a threshold duration, and wherein a duration between applying the first control message and triggering the cell switch procedure satisfies the threshold duration.

21. The apparatus of claim 13, wherein the instructions are further executable by the one or more processors to cause the apparatus to:
apply the configuration associated with the UE based at least in part on the configuration indicated via the first control message.

22. The apparatus of claim 21, wherein the configuration is associated with a plurality of cells of the network entity, the plurality of cells including at least the first cell and the second cell.

23. The apparatus of claim 12, wherein the UE transmits the indication that the UE discarded the configuration associated with the first control message.

24. The apparatus of claim 23, wherein the instructions are further executable by the one or more processors to cause the apparatus to:
discard the configuration associated with the UE based at least in part on the configuration indicated via the first control message.

25. The apparatus of claim 23, wherein the instructions are further executable by the one or more processors to cause the apparatus to:
discard the configuration associated with the first control message based at least in part on the first control message being received within the threshold duration of receipt of the second control message.

26. An apparatus for wireless communications at a first cell of a network entity, comprising:
one or more processors;
one or more memories coupled with the one or more processors; and
instructions stored in the one or more memories and executable by the one or more processors to cause the apparatus to:
transmit, to a second cell, a first control message indicating a configuration associated with a user equipment (UE); and
receive, from the second cell, an indication that the second cell refrained from forwarding the first control message.

27. The apparatus of claim 26, wherein receiving the indication that the second cell refrained from forwarding the first control message is based at least in part on transmitting the first control message within a threshold duration of a second control message.

28. The apparatus of claim 27, wherein the first control message is a radio resource control (RRC) message, and wherein the second control message is a layer 1 (L1)/layer 2 (L2) triggered mobility (LTM) message.

29. The apparatus of claim 26, wherein the first cell is a central unit of the network entity and the second cell is a distributed unit of the network entity.

30. A method for wireless communications at a first cell of a network entity, comprising:
receiving a first control message indicating a configuration associated with a user equipment (UE);
identifying a condition associated with transmitting a second control message indicating for the UE to perform a cell switch procedure to switch communications with the first cell to a second cell of the network entity; and
determining whether to forward the first control message to the UE based at least in part on the condition.
